(19) United States
(12) Patent Application Publication
(10) Pub. No.: US 2017/0079281 A1
(43) Pub. Date: Mar. 23, 2017

(54) CITRUS-BASED ANTIMICROBIAL COMPOSITION

(71) Applicant: BIOSECUR LAB INC., Mont-St-Hilaire (CA)

(72) Inventors: Yves Methot, Mont St-Hilaire (CA); Dieter Essler-Gravesen, Risskov (DK); Jean Talbot, St-Mathias (CA)

(21) Appl. No.: 15/271,645

(22) Filed: Sep. 21, 2016

Related U.S. Application Data
(60) Provisional application No. 62/221,268, filed on Sep. 21, 2015.

(30) Foreign Application Priority Data
Jul. 7, 2016 (CA) 2935632

(51) Int. Cl. A01N 65/36; A23L 3/3463; A01N 25/00

(52) U.S. Cl. CPC A01N 65/36; A01N 25/00; A23L 3/3463; A23V 2002/00

(57) ABSTRACT

Citrus-based antimicrobial compositions having broad spectrum antimicrobial activity against microorganisms such as bacteria, yeast, molds and fungi are described. The citrus-based antimicrobial compositions are suitable for use in food products, personal care products, oral products, or as surface/topical antimicrobials. The antimicrobial compositions generally comprise citrus extract as the principal antimicrobial ingredient, as well as a relatively low concentration of lauric arginate as an additive. In some embodiments, advantageous ingredient ratios of the citrus extracts to lauric arginate are provided. In some embodiments, formulations comprising the citrus-based antimicrobial compositions and taste-enhancing agents are provided, which mask the unpleasant taste that may be associated with the citrus extract, allowing for its use in food products. Methods of preparing antimicrobial citrus extracts and antimicrobial compositions, uses thereof, and products comprising same are also described.

The present description relates to antimicrobial compositions. Specifically, the present description relates to citrus-based antimicrobial compositions and/or preservatives. More specifically, the present description relates to antimicrobial compositions and/or preservatives comprising citrus extract and lauric arginate. The present description refers to a number of documents, the content of which is herein incorporated by reference in their entirety.

### BACKGROUND

Microbial pathogens are a serious global health concern responsible for millions of food-borne and other illnesses each year. Artificial or chemical antimicrobials are widely employed to control or prevent microorganism growth. For example, antimicrobials added directly to food products play a role in inhibiting the growth of or inactivating harmful microorganisms. Antimicrobials that are commonly used in food and other consumer products include benzoates (e.g., sodium benzoate, potassium benzoate), benzyl alcohol, sorbates, nitrites, sulfites, chelators, and phosphates. In this regard, it has been suggested that the use of artificial additives and preservatives in food products is linked to a number of health concerns (e.g., may exacerbate breathing problems in asthmatics; increased hyperactivity behaviour in children).

In response to the growing consumer demand for reducing the presence of artificial preservatives and antimicrobials, industries are leaning more and more towards the use of natural ingredients as preservatives/antimicrobials, particularly in food products. Furthermore, there is an increasing demand for “clean labelling”, which relates to minimizing and/or simplifying the ingredient list (e.g., in food products) for the consumer. However, developing effective natural antimicrobials can be a challenge, given that some antimicrobials lose their activity and/or stability over time when employed in combination with, or when exposed to, other compounds or ingredients. For example, some antimicrobials lose their antimicrobial activity when added to complex foods or food products, and/or may also negatively affect the physicochemical properties and/or integrity of the food products. Furthermore, antimicrobials to be used in food products present the additional hurdle of being neutral or appealing from an organoleptic standpoint.

Thus, there is a need for effective antimicrobial compositions and/or preservatives based on natural ingredients, particularly those having a minimal list of ingredients. There is also a need for natural antimicrobial compositions that are suitable for use in food products.

### SUMMARY

Antimicrobial citrus extracts possess broad-spectrum antimicrobial activity, but their relatively high production cost in comparison to some non-natural antimicrobial extracts, as well as the relatively high concentrations of the citrus extracts necessary to achieve sufficient antimicrobial effects, are obstacles to their widespread use. Furthermore, the unpleasant taste of antimicrobial citrus extracts when used at higher concentrations precludes their inclusion in many food products. The present inventors' efforts to mask the unpleasant taste of the citrus extracts by formulating them with various additives (e.g., taste-improving agents) revealed that some additives diminished the antimicrobial efficacy of the citrus extract. Thus, ways of lowering the effective concentration of citrus extracts, and ways of increasing their resistance to combination with additives would be highly desirable.

The present description stems from the surprising discovery that citrus-based antimicrobial compositions having advantageous properties may be produced by combining citrus extract with relatively low amounts of lauric arginate as a processing aid/stabilizer. For example, such compositions are able to employ lower doses of citrus extract in order to achieve sufficient antimicrobial effects, and/or are better able to resist losing their antimicrobial efficacy when combined with some additives (e.g., taste-improving agents), as compared to the citrus extract alone. Surprisingly, the concentrations of lauric arginate necessary to achieve these effects in final working dilutions of the citrus-based antimicrobial compositions described herein, are below that recognized by some regulatory agencies to qualify lauric arginate as an antimicrobial agent when used alone. Accordingly, the antimicrobial compositions described herein remain “citrus-based” antimicrobial compositions, which advantageously cater to the growing “clean labeling” demands from consumers, for example by being able to indicate citrus extract as the sole active antimicrobial ingredient/preservative in a final product. To this effect, the present description discloses advantageous concentration ratios of citrus extract to lauric arginate, which enables dilution to a working concentration comprising an active antimicrobial concentration of citrus extract, and a sub-antimicrobial concentration of lauric arginate.

In some aspects, the present description relates to one or more of the following items:
1. A citrus-based antimicrobial composition comprising citrus extract and lauric arginate.
2. The citrus-based antimicrobial composition of claim 1 consisting essentially of citrus extract and lauric arginate as a processing aid and/or stabilizer.
3. The composition of claim 1, wherein said citrus extract is, or is from, an aqueous citrus extract comprising a total bioflavonoid concentration of at least 0.3%, 0.35%, 0.4%, 0.45%, or 0.5% by mass, and a total polyphenol concentration of at least 2%, 2.1%, 2.2%, 2.3%, 2.4%, 2.5%, 2.6%, or 2.7% by mass, based on the total mass of the aqueous citrus extract.
4. The composition of claim 1, wherein said citrus extract is, or is from, an aqueous citrus extract comprising a total bioflavonoid concentration of 0.2% to 1.5% by mass, and a total polyphenol concentration of 1.5% to 6% by mass, based on the total mass of the aqueous citrus extract.
5. The composition of claim 1, wherein: (i) the ratio of citrus extract to lauric arginate by mass in said composition is between 1.5:1 and 6:1, between 2:1 and 6:1, between 2.5:1 and 6:1, between 3:1 and 6:1, between 4:1 and 5.5:1, between 4:1 and 5:1, or about 4.5:1; (ii) the ratio of total bioflavonoids to lauric arginate by mass in said composition is equivalent to that defined in (i), based on the aqueous citrus extract as defined in claim 3; (iii) the ratio of total polyphenols to lauric arginate by mass in said composition is equivalent to that defined in (i), based on the aqueous citrus extract as defined in claim 3; or (iv) any combination of (i) to (iii).
6. The composition of claim 1, wherein said citrus extract: (a) comprises an extract from Citrus aurantium amara; (b) comprises an extract from Citrus reticulate; (c) comprises an extract from Citrus sinensis; (d) does not comprise an extract from Citrus paradise; or (e) any combination of (a) to (d).
7. The composition of claim 1, wherein said composition further comprises an additive, a suitable carrier, stabilizer, taste-improving agent, or any combination thereof.
8. The composition of claim 7, wherein: (i) said additive comprises citrus bioflavonoids and/or citrus polyphenols; (ii) said suitable carrier comprises glycerin and/or silicon dioxide; (iii) said stabilizer comprises ascorbic acid, citric acid, lactic acid, or any combination thereof; (iv) said taste-improving agent is a sweetener, a natural sweetener, a polysaccharide, an oligosaccharide, a fructooligosaccharide, a maltodextrin, sucrose, sucralose, isomerized sugar, glucose, fructose, lactose, maltose, xylose, isomerized lactose, maltooligosaccharide, isomaltooligosaccharide, galactooligosaccharide, coupling sugar, paratinose, maltitol, sorbitol, erythritol, xylitol, lactitol, paratinit, saccharification product of reduced starch, stevia, glycyrrhizin, thaumatin, monelin, aspartame, alitame, saccharin, acesulfame-K, sucralose, dulcin, neotame, agave syrup, a low glycemic index carbohydrate, or any combination thereof; or (v) any combination of (i) to (iv).
9. The composition of claim 1, wherein said composition does not comprise a further antimicrobial agent.
10. The composition of claim 1, wherein said composition does not comprise a further antimicrobial agent which is a benzoate, a benzoate salt, benzyl alcohol, or any combination thereof.
11. The composition of claim 1, wherein said composition does not comprise a further antimicrobial agent which is thymol.
12. The composition of claim 1, wherein said composition does not comprise a further antimicrobial agent which is an essential oil and/or phenylethanol.
13. The composition of claim 1, wherein said composition does not comprise a further antimicrobial agent which is a quaternary compound and/or a quaternary ammonium compound.
14. The composition of claim 3, wherein said composition comprises between 30, 40, 50, 60, 70, 10, 90, or 100 ppm and 200, 250, 300, 350, 400, 450, 500, 550, or 600 ppm of said citrus extract.
15. The composition of claim 3, wherein said composition comprises a concentration of lauric arginate of between 30, 35, 40, 45, or 50 ppm and 55, 60, 65, 70, 75, 80, 85, 90, 95, or 100 ppm.
16. The composition of claim 1, wherein said composition is in the form of a concentrate, a liquid, a gel, a powder, or a solid.
17. The composition of claim 1, wherein said composition is formulated as a flavoring agent, a colorant, an antioxidant, a preservative, or any combination thereof.
18. The composition of claim 1, wherein said composition is comprised in or on a food product, a cosmetic, a personal care product, an oral care product, an industrial, or a pharmaceutical, or a surface antimicrobial.
19. A method for preparing a citrus-based antimicrobial composition, said composition consisting essentially of a citrus extract, lauric arginate as a processing aid and/or stabilizer, and a taste-improving agent, said method comprising: (a) dissolving said lauric arginate in demineralized water to form mixture I; (b) dissolving said taste-improving agent in demineralized water heated to between 65° C. and 75° C., or to about 70° C., to form mixture II; (c) mixing mixtures I and II to form mixture III, while maintaining a temperature at a minimum of 60° C.; and (d) adding citrus extract to mixture III, thereby preparing said citrus-based antimicrobial composition.
20. A citrus-based antimicrobial composition consisting of: (a) an aqueous citrus extract, lauric arginate as a processing aid and/or stabilizer, and water; or (b) an aqueous citrus extract, lauric arginate as a processing aid and/or stabilizer, water, and one of more of an additive, a suitable carrier, a stabilizer, and a taste-improving agent; wherein said citrus extract, before being added to said composition, comprises a total bioflavonoid concentration of 0.2% to 1.5% by mass, and a total polyphenol concentration of 1.5% to 6% by mass, based on the total mass of the aqueous citrus extract; and wherein the ratio of citrus extract to lauric arginate by mass in said composition is between 1.5:1 and 6:1, between 2:1 and 6:1, between 2.5:1 and 6:1, between 3:1 and 6:1, between 4:1 and 5.5:1, between 4:1 and 5:1, or about 4.5:1.

### GENERAL DEFINITIONS

Headings, and other identifiers, e.g., (a), (b), (i), (ii), etc., are presented merely for ease of reading the specification and claims. The use of headings or other identifiers in the specification or claims does not necessarily require the steps or elements be performed in alphabetical or numerical order or the order in which they are presented.

The use of the word “a” or “an” when used in conjunction with the term “comprising” in the claims and/or the specification may mean “one” but it is also consistent with the meaning of “one or more”, “at least one”, and “one or more than one”.

The term “about” or “approximately” is used to indicate that a value includes the standard deviation of error for the device or method being employed to determine the value. In general, the terminology “about” is meant to designate a possible variation of up to 10%. Therefore, a variation of 1, 2, 3, 4, 5, 6, 7, 8, 9 and 10% of a value is included in the term “about”. Unless indicated otherwise, use of the term “about” before a range applies to both ends of the range.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, un-recited elements or method steps.

Other objects, advantages and features of the present description will become more apparent upon reading of the following non-restrictive description of specific embodiments thereof, given by way of example only with reference to the accompanying drawings.

### BRIEF DESCRIPTION OF THE DRAWINGS

In the appended drawings:

FIG. 1 shows the antimicrobial effect of different concentrations of organic citrus extract (100-400 ppm) on a mixed salad product inoculated with Listeria monocytogenes and incubated for 24 hours at 4° C. The control (“reference”) corresponds to an untreated product (without the organic citrus extract).

FIG. 2 shows the effect of a citrus-based antimicrobial composition containing a mixture organic citrus extract (296 ppm) and lauric arginate (59 ppm) in pasteurized orange juice or apple juice inoculated with Saccharomyces cerevisiae, Zygosaccharomyces bailii, and Candida lipolytica, and incubated for at least 21 days at 7±1° C.

FIGS. 3A-5B show the effect of a citrus-based antimicrobial composition containing organic citrus extract, lauric arginate, and a taste-improving agent, on the growth of various microorganisms in inoculated strawberry fillings, as compared to sodium benzoate. Results with gram-negative bacteria are shown in FIG. 3 (FIG. 3A: E. coli; FIG. 3B: S. typhimurium), gram-positive bacteria are shown in FIG. 4 (FIG. 4A: L. monocytogenes; FIG. 4B: S. aureus; FIG. 4C: B. cereus), and yeasts/molds are shown in FIG. 5 (FIG. 5A: A. niger, FIG. 5B: Z. rouxii).

FIGS. 6A-7B show the effect of a citrus-based antimicrobial composition containing organic citrus extract, lauric arginate, and a taste-improving agent, on the growth of various microorganisms in inoculated strawberry flavor puddings, as compared to sodium benzoate. Results with gram-positive bacteria are shown in FIG. 6 (FIG. 6A: S. aureus; FIG. 6B: B. cereus), and yeasts/molds are shown in FIG. 7 (FIG. 7A: X. bisporus; FIG. 7B: Z. rouxii).

FIGS. 8A-8B shows the results of accelerated shelf-life testing of strawberry fillings containing 0.2% by mass Composition A, 0.1% by mass sodium benzoate, or no antimicrobial agent (control). The concentration of total aerobic microflora (TAM) (FIG. 8A), and the concentration of yeasts/molds (FIG. 8B) were determined by in strawberry filling samples stored at 28° C. under 70% relative humidity, in order to simulate an accelerated product maturity.

FIG. 9 shows the results of accelerated shelf-life testing of strawberry flavor puddings containing 0.2% by mass Composition A, 0.1% by mass sodium benzoate, or no antimicrobial agent (control). The concentration of total aerobic microflora (TAM) was determined by in strawberry flavor pudding samples stored at 28° C. under 70% relative humidity, in order to simulate an accelerated product maturity.

### DETAILED DESCRIPTION

The present description stems from the surprising discovery that citrus-based antimicrobial compositions having advantageous properties may be produced by combining citrus extract with relatively low amounts of the lauric arginate as an additive. Accordingly, in some aspects, the present description relates to a citrus-based antimicrobial composition comprising citrus extract and a cationic surfactant (e.g., lauric arginate).

As used herein, “antimicrobial” refers to the microbicidal or microbistatic properties of a compound, composition, article, or material that enables it to kill, destroy, inactivate, or neutralize a microorganism; or to prevent or reduce the growth, ability to survive, or propagation of a microorganism. As used herein, “microorganism” includes organisms such as bacteria, yeast, molds, and fungi. In some embodiments, the antimicrobial activity of a compound or composition can be evaluated by measuring a minimum inhibitory concentration (MIC), which is defined as the lowest concentration of an antimicrobial that will inhibit the visible growth of a microorganism after a standardized incubation (Andrews, 2002). In some embodiments, the antimicrobial activity of a compound or composition can be evaluated by measuring a minimum bactericidal concentration (MBC), which is defined as the lowest concentration of an antimicrobial agent required to kill a particular microorganism (Andrews, 2002). As used herein, the expression “minimum bactericidal concentration” is meant to be used synonymously with “minimum microbicidal concentration” (MMC), in cases where the microorganism being measured is not a bacterium.

As used herein, the expression “citrus-based” in the context of antimicrobial compositions of the present description refers to the presence of a citrus extract as the major or principal antimicrobial active agent in the antimicrobial composition to the effect that, if the citrus extract was removed from the composition, the composition would exhibit insufficient antimicrobial activity. For example, in some embodiments, the antimicrobial compositions of the present description may comprise other antimicrobial agents, but comprise citrus extract at a higher amount by mass as compared to other antimicrobial agents. In some embodiments, the other antimicrobial agents may be present in antimicrobial compositions of the present description at amounts that are sufficiently low such that their antimicrobial efficacy for the intended usage (e.g., in food products, cosmetics, as a surface antimicrobial) may not be recognized (e.g., by regulatory authorities), and thus may be considered as an additive or a processing aid.

In some embodiments, compositions of the present description possess broad-spectrum antimicrobial activity. As used herein, the expression “broad-spectrum” refers to the property or capability of a material to inactivate, inhibit, or kill numerous different types of microorganisms including bacteria, yeast, molds and fungi. An antimicrobial agent that inactivates only a select group of microorganisms (e.g., either only gram positive cells or only gram negative cells) does not have broad spectrum antimicrobial activity.

As used herein, “citrus extract” or “citrus fruit extract” refers to a composition obtained from the extraction of water-soluble compounds from the fruits of plants belonging to the genus Citrus. In some embodiments, the citrus extract may include extracts from the fruits of one or more citrus species such as Citrus aurantium amara (commonly known as bitter orange, sour orange, Seville orange, or marmalade orange), Citrus reticulate (commonly known as mandarin orange), and Citrus sinensis (commonly known as sweet orange or navel orange). Extracts from other citrus fruits may also be used, depending for example on seasonal availability, cost, and the concentration of active antimicrobial ingredients present in such fruits.

Citrus extracts useful in compositions of the present description possess antimicrobial activity. Without being bound by theory, the antimicrobial activity of citrus extracts may be due to, or associated with, the presence of polyphenols and/or bioflavonoids, in the citrus extracts. In some embodiments, antimicrobial compositions of the present description may comprise, or be obtained from, an aqueous citrus extract comprising a total bioflavonoid concentration of at least 0.3%, 0.35%, 0.4%, 0.45%, or 0.5% by mass, and/or a total polyphenol concentration of at least 2%, 2.1%, 2.2%, 2.3%, 2.4%, 2.5%, 2.6%, or 2.7% by mass, based on the total mass of the aqueous citrus extract. In some embodiments, the antimicrobial compositions of the present description may comprise, or be obtained from, an aqueous citrus extract comprising a total bioflavonoid concentration of 0.2% to 1.5% by mass, and/or a total polyphenol concentration of 1.5% to 6% by mass, based on the total mass of the aqueous citrus extract. Citrus extracts having higher percentages of polyphenols and/or bioflavonoids that those mentioned above would be advantageous. In some embodiments, citrus-derived polyphenols and/or bioflavonoids may be concentrated or purified, and then added as an additive in order to increase the concentration of polyphenols and/or bioflavonoids in the citrus extract and/or antimicrobial composition of the present description. The levels of total or specific bioflavonoids and/or polyphenols may be determined using known methods, such as via spectrophotometric analysis by Folin-Ciocalteu Method, and expressed in terms of equivalents (e.g., quercetin, rutin, hesperidin, or gallic acid equivalents).

In some embodiments, antimicrobial compositions of the present description may comprise an “organic citrus extract”, which refers to an extract that has been obtained from organic citrus fruits. It has been suggested that such fruits may contain higher amounts of polyphenols and/or bioflavonoids, as compared to non-organic citrus fruits.

In some embodiments, citrus extracts comprised in antimicrobial compositions of the present description do not comprise extracts from Citrus paradise (grapefruit). In this regard, grapefruit has been shown to have a number of interactions with drugs, which may preclude use of grapefruit extracts in food products.

In some aspects, antimicrobial compositions of the present description may comprise lauric arginate (also known as ethyl lauroyl arginate, lauramide ethyl ester, or lauramide arginine ethyl ester (LAE)). In some embodiments, lauric arginate may be formed by esterfying arginine with ethanol, and subsequently reacting the ester with lauroyl chloride. The resultant ethyl lauroyl arginate is recoverable as a hydrochloride salt. Lauric arginate may be purchased commercially from a number of suppliers and in different forms. In some embodiments, the concentrations and/or ratios of the present description refer to a lauric arginate source that is at least 90-95% pure. Other forms, sources or variants of lauric arginate are also within the scope of the present description.

In some embodiments, it may be desirable to keep the concentration of lauric arginate in the antimicrobial compositions of the present description as low as possible for a variety of reasons (e.g., antimicrobial efficacy, cost of raw materials, regulatory requirements, or to satisfy “clean labeling” demands from consumers). In some embodiments, the concentration of lauric arginate in the final product (e.g., a food product, cosmetic, or working dilution of a surface antimicrobial) is below that which is considered as having antimicrobial activity for the intended usage. As used herein, this sub-antimicrobial concentration of lauric arginate is reflected by the expression “lauric arginate as a processing aid and/or stabilizer”. Advantageously, this relatively low concentration of lauric arginate may benefit “clean label” applications of the citrus-based antimicrobial compositions of the present description, for example, by being able to indicate citrus extract as the sole active antimicrobial ingredient in a final product. To this effect, the present description discloses advantageous concentration ratios of citrus extract to lauric arginate, which enables dilution to a working concentration comprising an active antimicrobial concentration of citrus extract, and a sub-antimicrobial concentration of lauric arginate. Accordingly, in some embodiments of antimicrobial compositions of the present description, the ratio of citrus extract to lauric arginate by mass in said composition may be between 1.5:1 and 6:1, between 2:1 and 6:1, between 2.5:1 and 6:1, between 3:1 and 6:1, between 4:1 and 5.5:1, or between 4:1 and 5:1. In some embodiments of antimicrobial compositions of the present description, the ratio of citrus extract to lauric arginate may be about 1, 1.5, 2, 2.5, 3, 3.5, 4, 4.5, 5, 5.5, or 6 to 1. It is understood that the above ratios are based on aqueous citrus extracts having total bioflavonoid and/or total polyphenol concentrations as described herein, and that the above mentioned ratios may change depending on the form (liquid, solid, gel, powder) and/or content (e.g., total bioflavonoid and/or total polyphenol content, presence of additives, stabilizers, etc.) of the citrus extract that is used as raw material. However, the skilled person would be able to adapt the ratios and concentrations accordingly, based on the composition of the organic citrus extracts disclosed herein (e.g., see Example 1). Accordingly, in some embodiments, the ratio of total bioflavonoids and/or total polyphenols to lauric arginate by mass in said composition may be equivalent to the ratios defined herein, based on the aqueous citrus extract as defined herein (e.g., in Example 1).

In some embodiments, antimicrobial compositions of the present description may prepared as concentrates (e.g., liquid, solid, gel, powder, pellets) comprising citrus extract and lauric arginate (as well as other components) in defined ratios, which may be reconstituted and/or diluted for use at a certain concentration or starting concentration. For example, concentrated antimicrobial compositions of the present description may be diluted and used in a product until a suitable level of antimicrobial activity is reached. In such concentrated antimicrobial compositions, the ratios of citrus extract to lauric arginate (and other components) by mass defined herein may be respected, but the actual concentrations of the ingredients would be higher in the concentrated antimicrobial composition than in the diluted antimicrobial composition.

In some embodiments, antimicrobial compositions of the present description (e.g., when employed as an antimicrobial and/or preservative) may comprise, be for use, or be dilutable, such that the concentration of citrus extract is between 30, 40, 50, 60, 70, 10, 90, or 100 ppm and 200, 250, 300, 350, 400, 450, 500, 550, or 600 ppm.

In some embodiments, antimicrobial compositions of the present description (e.g., when employed as an antimicrobial or preservative) may comprise, be for use at, or be dilutable, such that the concentration of lauric arginate in the final product is below that which is considered as having antimicrobial activity, and thus qualifying lauric arginate as a “processing aid”. In some embodiments, antimicrobial compositions of the present description (e.g., when employed as an antimicrobial or preservative) may comprise, be for use at, or be dilutable, such that the concentration of lauric arginate is between 30, 35, 40, 45, or 50 ppm and 55, 60, 65, 70, 75, 80, 85, 90, 95, or 100 ppm.

In some embodiments, citrus extracts and/or antimicrobial compositions of the present description may comprise one or more carriers, stabilizers, taste-improving agents, and other additives.

In some embodiments, citrus extracts and/or antimicrobial compositions of the present description may comprise a citrus bioflavonoid and/or citrus polyphenol as an additive.

In some embodiments, citrus extracts and/or antimicrobial compositions of the present description may comprise a suitable carrier such as glycerin and/or silicon dioxide.

In some embodiments, citrus extracts and/or antimicrobial compositions of the present description may comprise a stabilizer such as an organic acid such as ascorbic acid, citric acid, lactic acid, or any combination thereof.

In some embodiments, citrus extracts and/or antimicrobial compositions of the present description may comprise a taste-improving agent. In some embodiments, the taste-improving agent may be a sweetener such as a natural sweetener. In some embodiments, the taste-improving agent may be a polysaccharide, an oligosaccharide, a fructooligosaccharide, a maltodextrin, sucrose, sucralose, isomerized sugar, glucose, fructose, lactose, maltose, xylose, isomerized lactose, maltooligosaccharide, isomaltooligosaccharide, galactooligosaccharide, coupling sugar, paratinose, maltitol, sorbitol, erythritol, xylitol, lactitol, paratinit, saccharification product of reduced starch, stevia, glycyrrhizin, thaumatin, monelin, aspartame, alitame, saccharin, acesulfame-K, sucralose, dulcin, neotame, agave syrup, a low glycemic index carbohydrate, etc., or any combination thereof.

In view of potential health concerns and/or growing consumer demand for “clean label” products, certain compounds or agents may be excluded from antimicrobial compositions of the present description. In some embodiments, antimicrobial compositions of the present description do not comprise a further antimicrobial agent, or do not comprise (e.g., as an antimicrobial agent): (a) a benzoate, a benzoate salt, benzyl alcohol, or any combination thereof; (b) thymol; (c) an essential oil and/or phenylethanol; (d) a quaternary compound and/or a quaternary ammonium compound; or (e) any combination of (a) to (d). In some embodiments, antimicrobial compositions of the present description are free from artificial (i.e., non-natural) ingredients. In some embodiments, antimicrobial compositions of the present description comprise only ingredients that are generally recognized as safe (GRAS). In some embodiments, antimicrobial compositions of the present description consist essentially of citrus extract and lauric arginate. As used herein within the context of antimicrobial compositions of the present description, “consists essentially of” refers to the lack of a sufficient amount of any other antimicrobial ingredient to be considered as an active ingredient (e.g., other antimicrobial ingredient is present at a concentration less than its MIC).

In some embodiments, citrus-extracts and/or antimicrobial compositions of the present description may be in the form of a concentrate, a liquid, a gel, a solid, a powder (e.g., lyophilized), pellets, or a spray. In some embodiments, citrus-extracts and/or antimicrobial compositions of the present description may be formulated as a flavoring agent, a colorant, an antioxidant, a preservative, or any combination thereof. In some embodiments, antimicrobial compositions of the present description may be encapsulated or microencapsulated.

In some embodiments, citrus-extracts and/or antimicrobial compositions of the present description may be for use as an antimicrobial agent and/or preservative agent in or on a food product, a cosmetic (e.g., cream, lotion), a personal care product (e.g., a deodorant), an oral care product (e.g., a dental rinse, a dentifrice), an industrial (e.g., disinfectant), or a pharmaceutical, or for use as a surface/topical antimicrobial. Accordingly, the present description also relates to a food product, cosmetic, personal care product, oral care product, an industrial, a pharmaceutical, or a surface/topical antimicrobial comprising an antimicrobial composition of the present description. In some embodiments, the ingredients of the antimicrobial compositions of the present description may be directly incorporated into a product, for example at the concentrations and/or ratios defined herein.

In some aspects, the present description relates to a method for preparing a citrus-based antimicrobial composition, the method comprising combining lauric arginate, citrus extract, and demineralized water with gentle mixing to minimize foaming. In some embodiments, a taste-improving agent or other additive may be added. In some embodiments, the taste-improving agent or other additive may be pre-dissolved in heated demineralized water for example to between about 65° C. and 75° C., and mixed with the lauric arginate dissolved in demineralized water, with the temperature preferably being kept at a minimum of about 60° C. Citrus extract may then be added. In embodiments, the amount of citrus extract and/or lauric arginate may be selected to respect the ratios and/or concentrations of each ingredient described herein.

In some aspects, the present description relates to one or more of the following items:
1. A citrus-based antimicrobial composition comprising citrus extract and lauric arginate.
2. A citrus-based antimicrobial composition consisting essentially of citrus extract and lauric arginate as a processing aid and/or stabilizer.
3. The composition of item 1 or 2, wherein said citrus extract is, or is from, an aqueous citrus extract comprising a total bioflavonoid concentration of at least 0.3%, 0.35%, 0.4%, 0.45%, or 0.5% by mass, and a total polyphenol concentration of at least 2%, 2.1%, 2.2%, 2.3%, 2.4%, 2.5%, 2.6%, or 2.7% by mass, based on the total mass of the aqueous citrus extract.
4. The composition of item 1 or 2, wherein said citrus extract is, or is from, an aqueous citrus extract comprising a total bioflavonoid concentration of 0.2% to 1.5% by mass, and a total polyphenol concentration of 1.5% to 6% by mass, based on the total mass of the aqueous citrus extract.
5. The composition of any one of items 1 to 4, wherein: (i) the ratio of citrus extract to lauric arginate by mass in said composition is between 1.5:1 and 6:1, between 2:1 and 6:1, between 2.5:1 and 6:1, between 3:1 and 6:1, between 4:1 and 5.5:1, between 4:1 and 5:1, or about 4.5:1; (ii) the ratio of total bioflavonoids to lauric arginate by mass in said composition is equivalent to that defined in (i), based on the aqueous citrus extract as defined in item 3 or 4; (iii) the ratio of total polyphenols to lauric arginate by mass in said composition is equivalent to that defined in (i), based on the aqueous citrus extract as defined in item 3 or 4; or (iv) any combination of (i) to (iii).
6. The composition of any one of items 1 to 5, wherein said citrus extract: (a) comprises an extract from Citrus aurantium amara; (b) comprises an extract from Citrus reticulate; (c) comprises an extract from Citrus sinensis; (d) does not comprise an extract from Citrus paradise; or (e) any combination of (a) to (d).
7. The composition of any one of items 1 to 5, wherein said composition comprises an additive, a suitable carrier, stabilizer, taste-improving agent, or any combination thereof.
8. The composition of item 7, wherein: (i) said additive comprises citrus bioflavonoids and/or citrus polyphenols; (ii) said suitable carrier comprises glycerin and/or silicon dioxide; (iii) said stabilizer comprises ascorbic acid, citric acid, lactic acid, or any combination thereof; (iv) said taste-improving agent is a sweetener, a natural sweetener, a polysaccharide, an oligosaccharide, a fructooligosaccharide, a maltodextrin, sucrose, sucralose, isomerized sugar, glucose, fructose, lactose, maltose, xylose, isomerized lactose, maltooligosaccharide, isomaltooligosaccharide, galactooligosaccharide, coupling sugar, paratinose, maltitol, sorbitol, erythritol, xylitol, lactitol, paratinit, saccharification product of reduced starch, stevia, glycyrrhizin, thaumatin, monelin, aspartame, alitame, saccharin, acesulfame-K, sucralose, dulcin, neotame, agave syrup, a low glycemic index carbohydrate, or any combination thereof; or (v) any combination of (i) to (iv).
9. The composition of any one of items 1 to 8, wherein said composition does not comprise a further antimicrobial agent.
10. The composition of any one of items 1 to 8, wherein said composition does not comprise a further antimicrobial agent which is a benzoate, a benzoate salt, benzyl alcohol, or any combination thereof.
11. The composition of any one of items 1 to 8 or 10, wherein said composition does not comprise a further antimicrobial agent which is thymol.
12. The composition of any one of items 1 to 8, 10 or 11, wherein said composition does not comprise a further antimicrobial agent which is an essential oil and/or phenylethanol.
13. The composition of any one of items 1 to 8 or 10 to 12, wherein said composition does not comprise a further antimicrobial agent which is a quaternary compound and/or a quaternary ammonium compound.
14. The composition of any one of items 1 to 13, wherein said composition comprises between 30, 40, 50, 60, 70, 10, 90, or 100 ppm and 200, 250, 300, 350, 400, 450, 500, 550, or 600 ppm of said citrus extract.
15. The composition of any one of items 1 to 13, wherein said composition is for use at a concentration of between 30, 40, 50, 60, 70, 80, 90, or 100 ppm and 200, 250, 300, 350, 400, 450, 500, 550, or 600 ppm of said citrus extract.
16. The composition of any one of items 1 to 15, wherein said composition comprises a concentration of lauric arginate of between 30, 35, 40, 45, or 50 ppm and 55, 60, 65, 70, 75, 80, 85, 90, 95, or 100 ppm.
17. The composition of any one of items 1 to 15, wherein said composition is for use at a concentration of lauric arginate between 30, 35, 40, 45, or 50 ppm and 55, 60, 65, 70, 75, 80, 85, 90, 95, or 100 ppm.
18. A citrus-based antimicrobial composition consisting of citrus extract, lauric arginate, and water; or citrus extract, lauric arginate, water and one of more of an additive, a suitable carrier, a stabilizer, and a taste-improving agent.
19. The composition of any one of items 1 to 18, wherein said composition is in the form of a concentrate, a liquid, a gel, a powder, or a solid.
20. The composition of any one of items 1 to 19, wherein said composition is formulated as a flavoring agent, a colorant, an antioxidant, a preservative, or any combination thereof.
21. The composition of any one of items 1 to 20, wherein said composition is for use as an antimicrobial agent and/or preservative agent in or on a food product, a cosmetic, a personal care product, an oral care product, an industrial, or a pharmaceutical, or for use as a surface antimicrobial.
22. Use of the composition as defined in any one of items 1 to 20 as an antimicrobial agent and/or preservative agent in or on a food product, a cosmetic, a personal care product, an oral care product, an industrial, or a pharmaceutical, or as a surface antimicrobial, or for the manufacture of same.
23. A method for preparing a citrus-based antimicrobial composition, said method comprising dissolving lauric arginate and citrus extract in demineralized water.
24. The method of item 23, further comprising adding a taste-improving agent.
25. The method of item 24, wherein: (a) said lauric arginate is dissolved in demineralized water to form mixture I; (b) said taste-improving agent is dissolved in demineralized water heated to between 65° C. and 75° C., or to about 70° C., to form mixture II; (c) mixing mixtures I and II to form mixture III, while maintaining a temperature at a minimum of 60° C.; and (d) adding citrus extract to mixture III.
26. The method of any one of items 23 to 25, wherein: (i) said citrus extract is as defined in items 3, 4 or 6; (ii) the ratio of citrus extract to lauric arginate is as defined in item 5; (iii) the taste-improving agent is as defined in item 8; or (iv) any combination of (i) to (iii).
27. A product comprising the citrus-based antimicrobial composition as defined in any one of items 1 to 20, wherein said product is a food product, a cosmetic, a personal care product, an oral care product, an industrial, or a pharmaceutical, or a surface antimicrobial.

The scope of the claims should not be limited by the preferred embodiments set forth in the examples, but should be given the broadest interpretation consistent with the description as a whole.

### EXAMPLES

### Example 1

### Preparation of Organic Citrus Extract

The commercially available organic citrus extract BIOSECUR® F440D-K (Biosecur Lab Inc., Canada; herein after “BIOSECUR®”) was used throughout the present examples as a source of citrus extract, although other citrus extracts such as those containing similar percentages of active ingredients (e.g., bioflavonoids and/or total polyphenols) may be substituted. BIOSECUR® is a water-soluble and alcohol-free hydro-glycerin citrus extract prepared from organic citrus fruits. It is available as a non-volatile honey-colored clear/transparent liquid with a density of 1.11-1.22 g/mL, and a pH ranging from 2.0-3.5. It has a light citrus odor and its taste is slightly acidic, sweet, and astringent.

BIOSECUR® is prepared from multiple species of organic citrus fruits of varying degrees/stages of maturity, including Citrus aurantium amara (commonly known as bitter orange, sour orange, Seville orange, or marmalade orange), Citrus reticulate (commonly known as mandarin orange), and Citrus sinensis (commonly known as sweet orange or navel orange). While the ratios of each of the citrus species used may vary based on seasonal availability, the end product contains between 0.5-1.2% bioflavonoids by mass, and between 2.7-5% polyphenols by mass.

Briefly, the fruits are selected, washed and peeled before entering the production phase. The resulting edible parts, including the albedo component, are extracted with water and glycerin by macerating the mixture. The pH of the mixture is adjusted to meet quality control standards, followed by a separation step to remove citrus solids. The resulting mixture is further concentrated and centrifuged. The supernatant (extract) is then quarantined prior to quality assessments, which includes total citrus polyphenols, ascorbic acid content, and acidity (pH). Additional raw materials (ascorbic acid, lactic acid, and citric acid) are added to the resulting extract, and this liquid is quarantined again to pass a second quality inspection that includes physical and chemical analysis, and organoleptic analyses. The quality control specifications and general composition for BIOSECUR® are provided in Tables 1.1 and 1.2.

TABLE 1.1
Quality control specifications of BIOSECUR ®

| Parameter | Specification | Method of determination |
|---|---|---|
| Liquid appearance | Viscous crystalline | Organoleptic procedure |
| | honey color, light | |
| | citrus odor | |
| Water solubility | 100% | USP XXII (1990) |
| Density (g/mL) | 1.19-1.22 | Pycnometer methods |
| pH at 25° C. (10% sol) | 2.0-3.5 | USP XXII (1990) |
| Acidity (mg)* | 1000-1300 | Adolfo Lutz Institute |
| | | methods |
| Ascorbic acid (%) | 4% min. by mass | AOAC 967.21 |
| Refraction rate | 1.47 (±2%) | Via hand-held refractometer |

USP: United States Pharmacopeia,
AOAC: Association of Analytical Chemists,
*Quantity of product neutralized by 1 mL of 0.1M NaOH.

TABLE 1.2
General composition of BIOSECUR ®

| Ingredient | Function | Concentration | | Method of determination |
|---|---|---|---|---|
| Total bioflavonoids | Active | 0.5%-1.2% | by mass | Spectrophotometric analysis by Folin-Ciocalteu |
| | | | | Method (quercetin, rutin, and hesperidin equivalents) |
| Total polyphenols | Active | 2.7-5% | by mass | Spectrophotometric analysis by Folin-Ciocalteu |
| | | | | Method (GAE) |
| Glycerin (%) | Carrier | 56-64% | by mass | GC-FID |
| Water | Carrier | Not applicable | | DEV-10-028 99.1-CDXA3.0000094 |
| | | | | (Karl Fisher Assay) |
| Ascorbic acid (%) | Stabilizer | 1.75-4% | by mass | HPLC |
| Citric acid (%) | Stabilizer | <2% | by mass | HPLC |
| Lactic acid (%) | Stabilizer | <2% | by mass | HPLC |

GAE: gallic acid equivalence method;
HPLC: High Performance Liquid Chromatography (HPLC)

### Example 2

### MIC and MBC Testing of Organic Citrus Extract in Suitable Growth Medium

### 2.1 Minimum Inhibitory Concentration (MIC) Testing

Minimum inhibitory concentrations (MICs) are defined as the lowest concentration of an antimicrobial that will inhibit the visible growth of a microorganism after a standardized incubation (Andrews, 2002). In the present study, the MIC of the organic citrus extract as described in Example 1 was determined by a standard microtiter plate assay. Briefly, an indicator microorganism at a defined cell density was cultured with a range of concentrations of the test compound (organic citrus extract), one concentration per well in a microtiter plate. For bacteria and yeasts, the minimal inhibitory concentration was detected as no increase of optical density (OD) within 48 h. Plates which contained molds as indicator strains were stored under ambient atmosphere until visible growth (mycelium) was detected. Each test microorganism was tested in duplicate, and the MIC was calculated as the average of the two determinations. The tested concentrations of the antimicrobial substances were 2-fold dilutions from 5000 ppm, i.e.: 5000, 2500, 1250, 625, 312.5, 156.3, 78.1, 39.1, 19.5, 9.8, and 4.9 ppm.

All test microorganisms were pre-cultivated in a suitable growth medium (generally Brain-heart Infusion (BHI) broth for most microorganisms; MRS broth for Lactobacillus farciminis; or Elliker broth for Lactobacillus sakei), grown at between 25° C. and 37° C. depending on the species, and diluted in the same medium to give a final concentration in the assay of 1×10⁵ CFU/mL. The antimicrobial solutions were made in sterile water. The microtiter plates were incubated under ambient atmosphere, except the plates with Clostridia sp. which were stored anaerobically. Results are shown in Table 2.1.

### 2.2 Minimum Bactericidal Concentration (MBC) Testing

Even when no growth is detectable in the MIC tests, it is possible that the microorganisms have survived the treatment, i.e. they are not killed, but just prevented from growing. In order to test for survivors, minimum bactericidal concentration (MBC), MBC plates were subsequently made from the MIC plates. After 48 hours, replicate microtiter plates were made, where the content of each well in the MIC plates was diluted 10-fold in fresh growth media in the MBC plate. The MBC plates were incubated at test organisms' optimal growth temperatures, and outgrowth was monitored after 24 and 48 hours. The minimal bactericidal concentration is defined as the lowest concentration where outgrowth does not occur, i.e. no survivors have been transferred from the MIC to the MBC plate (approx. 3 log reductions), and the MBC is calculated as the average of the duplicate determination. Results are shown in Table 2.1.

TABLE 2.1
MIC and MBC of organic citrus extract
against different microorganisms

| | | | MBC |
|---|---|---|---|
| Microorganism | Strain | MIC (ppm) | (ppm) |
| Aeromonas hydrophila | | 110 | — |
| Aspergillus flavus | ISI 3 | 313 | — |
| Bacillus cereus | L8PQ | 750 | — |
| Bacillus cereus | ISI 4 | 39 | 39 |
| Brochothrix thermosphacta | | 20 | — |
| Brochothrix thermosphacta | ISI 6 | 20 | 20 |
| Candida lipolytica | ISI 140 | 39 | 78 |
| Candida tropicalis | | 20 | — |
| Candida zeylanoides | ISI 138 | 39 | 39 |
| Citrobacter freundii | | 390 | — |
| Clostridium sporogenes | ISI 11 | 78 | 938 |
| Clostridium tyrobutyricum | ISI 10 | 78 | 1250 |
| Debaryomyces hansenii | | 39 | — |
| Debaryomyces hansenii | ISI 12 | 20 | 20 |
| Enterococcus faecalis | ISI 48 | 78 | 78 |
| Enterococcus faecium | | 50 | — |
| Enterococcus faecium | ISI 13 | 39 | 78 |
| Escherichia coli | EDL 933 | 240 | — |
| Escherichia coli | ISI 14 | 39 | 39 |
| Klebsiella oxytoca | ISI 15 | 256 | |
| Kluyveromyces marxianus | ISI 104 | 39 | 39 |
| Listeria monocytogenes | ISI 20 | 78 | 78 |
| Listeria monocytogenes | HPB 2812 | 20 | |
| Listeria monocytogenes 1/2c | ISI 26 | 39 | 39 |
| Listeria monocytogenes 4a | ISI 28 | 39 | 59 |
| Listeria monocytogenes 4b | ISI 25 | 59 | 78 |
| Listeria monocytogenes 4b | ISI 27 | 39 | 39 |
| Lactobacillus farciminis | | 195 | — |
| Lactobacillus sakei | | 125 | — |
| Lactobacillus sakei | ISI 16 | 156 | 156 |
| Leuconostoc mesenteroides | ISI 47 | 156 | 313 |
| Mucor sp. | ISI 88 | 156 | |
| Penicillium furcalum | ISI 62 | 156 | |
| Pseudomonas aeruginosa | ISI 30 | >5000 | >5000 |
| Pseudomonas fluorescens | ISI 29 | 1250 | 1250 |
| Pseudomonas fluorescens | | 1000 | |
| Rhodotorula mucilaginosa | ISI 33 | 78 | 156 |
| Saccharomyces cerevisiae | ISI 109 | 625 | 625 |
| Salmonella enteritidis PT14b | ISI 169 | 625 | 1250 |
| Salmonella enteritidis PT30 | ISI 203 | 625 | 938 |
| Salmonella enteritidis PT8 | ISI 168 | 313 | 938 |
| Salmonella infantis FT8 | ISI 170 | 469 | 625 |
| Salmonella London | ISI 174 | 313 | |
| Salmonella senftenberg | ISI 172 | 313 | 1875 |
| Salmonella typhimurium DT12 | ISI 166 | 313 | 625 |
| Salmonella typhimurium DT120 | ISI 167 | 313 | 1250 |
| Shigella sonnei | | 256 | — |
| Shigella sonnei | ISI 35 | 625 | 625 |
| Staphylococcus aureus | ISI 36 | 1250 | 1250 |
| Staphylococcus aureus | ATCC 25923 | 20 | — |
| Staphylococcus epidermidis | | 78 | — |
| Zygosaccharomyces rouxii | ATCC R 995 | 78 | — |
| Zygosaccharomyces rouxii | ISI 38 | 39 | 39 |

“—”: not determined

### Example 3

### Antimicrobial Efficacy Testing of Organic Citrus Extract in Food Products

In general, it can be expected that the concentration of an antimicrobial needed in practice (e.g., in a food product, cosmetic, surface/topical antimicrobial) is higher than the MIC determined in laboratory media. Thus, the antimicrobial efficacy of the organic citrus extract as described in Example 1 was examined in various food products including raw ham, iceberg lettuce, and a mixed salad product.

### 3.1 Listeria

### 3.1.1 Methods

(A) Preparation of the Listeria monocytogenes Inoculum

An inoculum was prepared according to the European Union legislation as described in the Technical Guidance Document On shelf-life studies for Listeria monocytogenes in ready-to-eat foods from the European Union Reference Laboratory for Listeria monocytogenes. Briefly, a pool of four strains of L. monocytogenes was prepared: L. monocytogenes ISI 20 (food isolate), L. monocytogenes ISI 21 (food isolate), L. monocytogenes ISI 22 (food isolate), and L. monocytogenes ISI 26 (clinical isolate, ATCC 7644). The four strains were cultured individually in two steps. The first sub-cultures were grown overnight in Brain-heart infusion (BHI) broth at 37° C. These cultures were diluted 1000-fold in fresh BHI and incubated at 8° C. for 5 days, resulting in cold-adapted cultures in early stationary growth phase. Subsequently, the four cold-adapted cultures are diluted in sterile dilution liquid and plated for determining the cell count. The cultures were stored overnight at 4° C., and finally the inoculum was prepared as a pool of the four cold-adapted cultures by mixing equal amounts of each strain. Two further dilutions were made to appropriate cell densities for reaching the target contamination levels of 100 and 1000 CFU/cm².

### (B) Microbiological Analyses

Quantitative enumeration of L. monocytogenes in situ was performed as described in ISO 11290-2:1998 Microbiology of food and animal feeding stuffs—Horizontal method for the detection and enumeration of Listeria monocytogenes—Part 2: Enumeration method with amendments. Enumeration was made on ALOA® plates (B10-RAD™). Detection limit: 5 CFU/g.

3.1.2 Effect of Organic Citrus Extract on L. monocytogenes in Raw Ham

A commercial raw ham product was used. Ham blocks were sliced in approximately 0.5 cm slices, each side having surface area of approximately 25 cm². One side of each slice was inoculated with 50 μL of the two dilutions of L. monocytogenes inoculum described in Example 3.1.1(A), and left at ambient temperature for approximately 30 minutes to allow attachment of the Listeria. Subsequently, the same surface was treated with 50 μL of the organic citrus extract solution of Example 1 giving a final concentration of 0.05 mg/cm². Duplicate samples were made. The samples were stored for 24 hours at 7° C. prior to analyses. Quantitative enumeration of L. monocytogenes in situ was performed as described in Example 3.1.1(B). The results summarized in Table 3.1 show that the organic citrus extract significantly reduced the counts of L. monocytogenes.

TABLE 3.1
Effect of organic citrus extract on raw ham
inoculated with L. monocytogenes

| | Dilution of | |
|---|---|---|
| | L. monocytogenes inoculum | |
| | 100 CFU/cm² | 1000 CFU/cm² |
| Control (untreated) | 172 CFU/cm² | 1690 CFU/cm² |
| Organic citrus extract (0.05 gm/cm²) | 7 CFU/cm² | 98 CFU/cm² |

3.1.3 Effect of Organic Citrus Extract on L. monocytogenes in Iceberg Salad

The cold-adapted inoculum was prepared as described in Example 3.1.1(A), except that the final dilution was made to an appropriate cell density for reaching the target contamination levels of 50-100 CFU/cm². Microbiological analyses were performed as described in Example 3.1.1(B), with a detection limit of 5 CFU/g or 1 CFU/cm².

Iceberg lettuce leaves were mounted on a cutting board, and a 25 cm² surface area was defined using tape. The defined surface area was contaminated with the cold-adapted L. monocytogenes at 25 CFU/cm², and left at ambient temperature for approximately 30 minutes. Duplicate samples were treated with various concentrations of the organic citrus extract of Example 1. The treated surface was cut out and stored at 4° C. for 24 h, after which enumeration of L. monocytogenes was performed. The results showed that even the lowest tested concentration the organic citrus extract (i.e., 0.0087 mg/cm²), reduced the counts of L. monocytogenes to below the detection limit of 1 CFU/cm².

Subsequently, the efficacy of the organic citrus extract over the shelf-life of the iceberg lettuce was evaluated by a similar defined surface test. The organic citrus extract was tested at 0.069 mg/cm², and triplicate samples were made. Samples were stored at 7° C. for 12 days and it was ensured that the iceberg did not dry out during storage.

The results showed that in the control (untreated) sample, L. monocytogenes grew from an initial average of 29 CFU/cm², to an average of 2×10⁴ CFU/cm². In contrast, L. monocytogenes was below the detection level of 1 CFU/cm² in all three samples treated with the organic citrus extract.

3.1.4 Effect of Organic Citrus Extract on L. monocytogenes in Mixed Salad

The cold-adapted inoculum was prepared as described in Example 3.1.1(A), except that the final dilution was made to an appropriate cell density for reaching the target contamination levels of 50-100 CFU/g. Microbiological analyses was performed as described in Example 3.1.1(B), with a detection limit of 5 CFU/g or 1 CFU/cm².

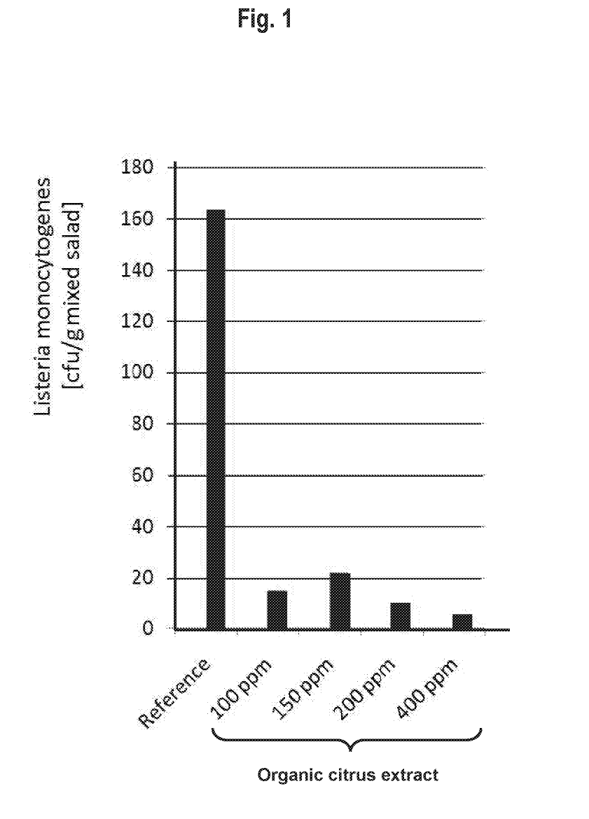

A commercial mixed salad product was tested. The samples were received as empty bowls and the various ingredients in separate zipper bags. The cut iceberg was weighed out in five bowls, 70 g in each. The portions of iceberg were contaminated with 1 mL of the cold-adapted L. monocytogenes, and the bowls were closed and mixed thoroughly to distribute the Listeria. The bowls were left for approximately 30 minutes at room temperature to allow for adsorption of the Listeria in order to mimic a contaminated raw material. The iceberg in the bowls was treated with the organic citrus extract of Example 1 by adding three sprays, in total 2.2 g, of the organic citrus extract at a concentration giving 100, 150, 200, and 400 ppm in the final mixed salad. The reference bowl was left untreated. The contents were mixed very thoroughly to distribute the organic citrus extract, before adding the remaining ingredients, which were 80 g of cooked pasta, 20 g of grated carrot, 30 g of chicken strips, and one hard-boiled egg cut into six pieces. The samples were stored at 4° C. for 24 hours prior to analyses. Each sample was split in three for analyses (i.e., triplicate analysis, all in all analyzing the entire sample). The cell densities of L. monocytogenes were calculated as averages of the three results and the results are shown in FIG. 1. The results indicate that the organic citrus extract retained its antimicrobial effect on L. monocytogenes in a mixed salad product.

3.2 Escherichia coli

Three studies on the organic citrus extract of Example 1 were performed to determine its effect on E. coli O157:H7, when suspended in “dirty” water or suspended on leafy greens (spinach sample). The test solutions tested in each of the studies are listed below:

| Test solutions | Concentration | pH |
|---|---|---|
| 1) Organic citrus extract of Example 1 | 0.5% by mass | 6.5 |
| 2) Organic citrus extract of Example 1 | 0.5% by mass | 3.1 |
| 3) Sodium hypochlorite | 20 ppm NaOCl | 6.5 |
| 4) Sodium hypochlorite | 20 ppm NaOCl | 3.1 |
| 5) Tap water (growth control) | n/a | 8.3 (“as is”) |

For all studies, E. coli cultures were prepared in suspension and then a separate aliquot of each culture was inoculated at 10⁵-10⁶ CFU/mL into the appropriate solution or spinach sample. The inoculated solutions/spinach samples were mixed, diluted and plated in <30 seconds. Cultures were held in the respective solutions/spinach samples for an additional 90 seconds and 5 minutes, serially diluted and plated. All plates were incubated at 35° C. for 48 hours and enumerated.

In the first study (study #1), each of the above test solutions were added to a culture of “dirty” water containing 03% albumin, following the British Standards, EN 1276:1997. The second study (study #2) was performed on washed spinach purchased at grocery store, and the third study (study #3) was performed on unwashed spinach. The results are reported below.

### Organic Citrus Extract Results

All three studies indicate that the organic citrus extract of Example 1 achieved a >5-log reduction against E. coli O157:H7 after <30 seconds, 90 seconds, and 5 minutes exposure times at both pH 6.5 and pH 3.1.

### NaOCl Control Results (pH 6.5):

Study #1: No log reduction at <30 seconds, 2.5-log reduction at 90 seconds & 5 minutes

Study #2: No log reduction at <30 seconds & 90 seconds, 1-log reduction at 5 minutes

Study #3: No log reduction at <30 seconds, 90 seconds & 5 minutes.

### NaOCl Control Results (pH 3.1):

Study #1: >5-log reduction at <30 seconds, 90 seconds & 5 minutes

Study #2: 1-log reduction at <30 seconds, 90 seconds & 5 minutes

Study #3: No log reduction at <30 seconds, 90 seconds & 5 minutes

### Tap Water Results:

Studies #1, 2 & 3: No log reduction at any of the three exposure times.

These results show that the organic citrus extract of Example 1 was effective in reducing E. coli O157:H7 to >5-log reductions within 30 seconds exposure time when suspended in “dirty” water or on leafy greens.

### Example 4

### MIC and MBC Testing of Organic Citrus Extract Combined with Lauric Arginate

Although the results presented in Example 3 show the broad-spectrum antimicrobial efficacy of the organic citrus extract of Example 1, its undesirable taste represents an obstacle for usage in food products that appeal to consumers. Attempts to mask or improve the undesirable taste of the organic citrus extract by diluting it in water and/or combining it with various additives (e.g., taste-improving agents) resulted in diminished antimicrobial efficacy of the citrus extract. A plurality of agents were thus screened individually for compatibility with the organic citrus extract of Example 1 (data not shown). Surprisingly, promising results were obtained by combining the organic citrus extract with the cationic surfactant lauric arginate.

### 4.1 MICs of Organic Citrus Extract and Lauric Arginate Against Different Fungi Species in Filtered Apple Juice

To evaluate the individual antifungal activities organic citrus extract and lauric arginate, their minimum inhibitory concentration (MIC) were determined against the following yeast strains: Saccharomyces cerevisiae (ISI107), Zygosaccharomyces bailii (ISI110), and Candida lipolytica (ISI140). These yeasts species are considered to be among the most relevant spoilage organisms in food products, in particular beverages (e.g., cold-filled ready-to-drink beverages, or low-pH beverages). Z. bailii is of particular concern for manufacturers of acidic products due its sorbate resistance. For example, it has been reported that Z. bailii yeasts can grow at sorbate levels of 500 ppm.

The organic citrus extract was obtained as described in Example 1, and the lauric arginate was purchased as a liquid containing 10.5% lauric arginate in glycerin as a carrier. MIC was determined by a standard microtiter plate assay in which an indicator microorganism at a defined cell density is cultured with a range of concentrations of the test compound (either organic citrus extract or lauric arginate). The MIC is the minimum inhibitory concentration is defined as the lowest concentration which completely prevents growth of the microorganism. All MIC tests in this Example were performed in filtered apple juice (pH 3.59) by measuring the optical density (OD) every 15 min for a minimum of 48 hours until growth was detectable in the control (without antimicrobial components). The samples were incubated at 25° C./77° F. aerobically. Initial MIC testing showed that the yeast S. cerevisiae ISI107 was the most resistant species among those tested against both organic citrus extract and lauric arginate (data not shown). The MIC testing results for S. cerevisiae ISI107 are shown in Table 4.1, in which cells highlighted in black indicate to concentrations in parts per million (ppm) without detectable growth of the yeast. Rows A and B show the results of experiments performed in duplicate.

TABLE 4.1
MIC of organic citrus extract and lauric arginate in ppm against S. cerevisiae ISI107

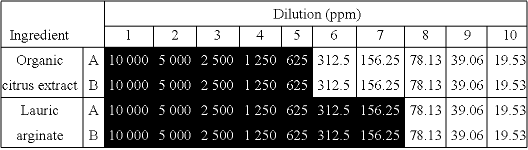

As shown in Table 4.1, the MIC of the organic citrus extract of Example 1 was about 625 ppm, and the MIC of lauric arginate was about 156 ppm, with respect to the yeast S. cerevisiae ISI107.

### 4.2 MIC of Compositions Containing Both Organic Citrus Extract and Lauric Arginate in Filtered Apple Juice

The antifungal activity of compositions containing both organic citrus extract and lauric arginate were explored. The compositions were prepared by mixing the organic citrus extract of Example 1 and lauric arginate liquid (containing 10.5% lauric arginate and glycerin as a carrier) directly in filtered apple juice.

The minimum inhibitory concentrations of compositions containing different ratios of organic citrus extract and lauric arginate were determined for the yeast strain Saccharomyces cerevisiae (ISI107), as described in Example 4.1. Typical results are shown in Table 4.2, in which cells highlighted in black and containing “−” indicate concentrations without detectable growth of the yeast, and cells containing “+” indicate concentrations resulting in detectable yeast growth. Cells containing “(+)” indicate intermediate yeast growth.

TABLE 4.2
MIC of compositions containing different ratios of organic citrus extract and lauric
arginate for inhibiting growth of S. cerevisiae ISI107

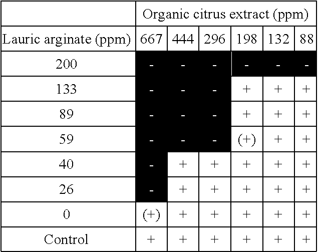

The results in Table 4.2 show that mixtures of organic citrus extract and lauric arginate can result in lower MICs for both ingredients, as compared to their MICs when employed individually. For example, the MIC of organic citrus extract could be lowered to about 296 ppm, when mixed with about at least 59 ppm of lauric arginate, representing a ratio of organic citrus extract to lauric arginate of about 5:1 by mass.

### 4.3 Challenge Tests in Orange and Apple Juice

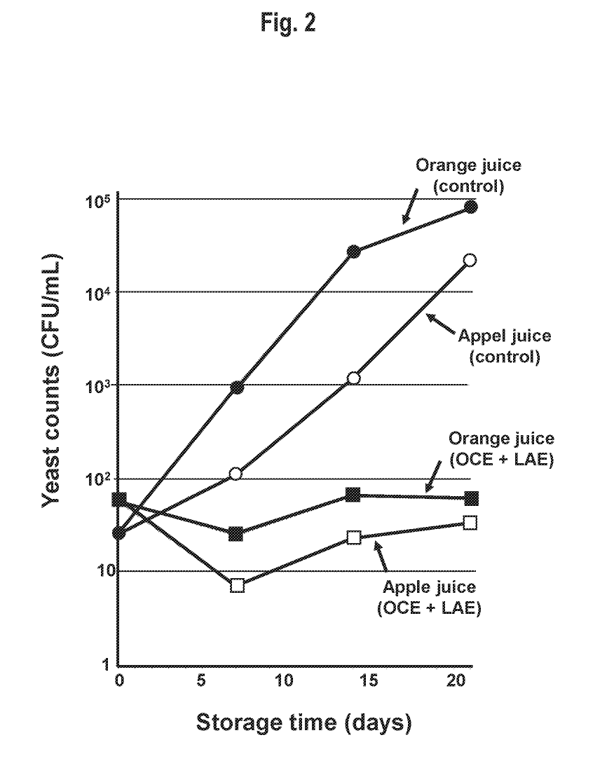

Challenge tests were conducted with orange juice (pH 3.54) and apple juice (pH 3.92). Both juices were bought at a local supermarket. The juices were pasteurized and did not contain any preservatives. The juices were filled into sterile bottles (each of 500 mL) and contaminated with the indicator yeasts (Saccharomyces cerevisiae ISI107, Zygosaccharomyces bailii ISI110, and Candida lipolytica ISI140) with total inoculation rates of approximately 100 CFU/mL. Half of the samples were treated with about 296 ppm of the organic citrus extract of Example 1 and about 59 ppm of lauric arginate. All samples were stored in a climate chamber at 7°±1° C. (44° F.). Yeasts counts were detected at days 0, 7, 14 and 21 on the selective Oxytetracycline Glucose Yeast Extract (OGYE) media (room temperature, 4 days). As can be seen in the results shown in FIG. 2, all samples incubated in the presence of both the organic citrus extract of Example 1 and lauric arginate remained below 100 CFU/mL throughout the study, while the untreated samples reached levels of between 10⁴ and 10⁵ CFU/mL by day 21 of storage.

### 4.4 MIC and MBC Testing of Solutions Containing Different Ratios of Organic Citrus Extract to Lauric Arginate

Concentrated stock solutions of organic citrus extract and lauric arginate were prepared by mixing the organic citrus extract of Example 1 and lauric arginate liquid (containing 10.5% lauric arginate and glycerin as a carrier), and water. Solutions containing different ratios of organic citrus extract to lauric arginate were prepared and tested. MIC and MBC testing was carried out as generally described in Examples 2.1 and 2.2. Typical results from a concentrated stock solution containing a ratio of organic citrus extract to lauric arginate of about 4.5:1 are shown below in Table 4.3 (see columns “MIC of mixture” and “MBC of mixture”). For ease of comparison with the organic citrus extract alone, relevant MIC and MBC values from Table 2.1 are included in Table 4.3 (see columns “MIC of OCE from Table 2.1” and “MBC of OCE from Table 2.1”). Also, the concentrations (in ppm) of each of the individual components of the mixture (see four right-most columns) are indicated. Values appearing in bold highlight the concentrations (in ppm) of the organic citrus extract component.

TABLE 4.3
MIC and MBC of mixture of organic citrus extract (OCE) and lauric arginate (LAE) against different microorganisms

| | | OCE from | | | | | | | |
|---|---|---|---|---|---|---|---|---|---|
| | | Example 1 (in ppm) | | Mixture of OCE and LAE from Example 5.1 (in ppm) | | | | | |
| | | MIC of | MBC of | | | Amount | Amount | Amount | Amount |
| | | OCE from | OCE from | MIC of | MBC of | of OCE | of LAE in | of OCE in | of LAE in |
| Microorganism | Strain | Table 2.1 | Table 2.1 | mixture | mixture | in MIC | MIC | MBC | MBC |
| Aspergillus niger | ISI 64 | — | — | 5000 | — | 760 | 170 | — | — |
| Bacillus cereus | ISI 4 | 39 | 39 | 156 | 156 | 24 | 5 | 24 | 5 |
| Brochothrix thermosphacta | ISI 6 | 20 | 20 | 117 | 313 | 18 | 4 | 48 | 11 |
| Byssoclamys nivea | ISI 831 | — | — | 2500 | — | 380 | 85 | — | — |
| Candida famata | ISI 93 | — | — | 30 | 156 | 5 | 1 | 24 | 5 |
| Candida lipolytica | ISI 140 | 39 | 78 | 313 | 625 | 48 | 11 | 95 | 21 |
| Candida sake | ISI 318 | — | — | 78 | 235 | 12 | 3 | 36 | 8 |
| Candida tropicalis | | 20 | — | — | — | — | — | — | — |
| Candida tropicalis | ISI 7 | — | — | 20 | 39 | 3 | 1 | 6 | 1 |
| Candida zeylanoides | ISI 138 | 39 | 39 | 156 | 156 | 24 | 5 | 24 | 5 |
| Camobacterium divergens | ISI 904 | — | — | 1250 | 6250 | 190 | 43 | 950 | 213 |
| Cladosporium cladosporioides | ISI 83 | — | — | 313 | 938 | 48 | 11 | 143 | 32 |
| Clostridium botulinum | ISI 920 | — | — | 156 | 313 | 24 | 5 | 48 | 11 |
| Clostridium perfringens | ISI 766 | — | — | 156 | 156 | 24 | 5 | 24 | 5 |
| Clostridium sporogenes | ISI 11 | 78 | 938 | — | — | — | — | — | — |
| Clostridium sporogenes | ISI 921 | — | — | 156 | 313 | 24 | 5 | 48 | 11 |
| Clostridium tyrobutyricum | ISI 10 | 78 | 1250 | 156 | 234 | 24* | 5 | 36* | 8 |
| Debaryomyces hansenii | | 39 | — | — | — | — | — | — | — |
| Debaryomyces hansenii | ISI 12 | 20 | 20 | 39 | 59 | 6* | 1 | 9* | 2 |
| Enterococcus faecalis | ISI 48 | 78 | 78 | 625 | 625 | 95 | 21 | 95 | 21 |
| Enterococcus faecium | ISI 13 | 39 | 78 | 625 | 625 | 95 | 21 | 95 | 21 |
| Escherichia coli O157 | ISI 276 | — | — | 625 | 625 | 95 | 21 | 95 | 21 |
| Escherichia coli O157 | ISI 278 | — | — | 625 | 625 | 95 | 21 | 95 | 21 |
| Eurotium chevalieri | ISI 331 | — | — | 1250 | — | 190 | 43 | — | — |
| Hafnia alvei | ISI 635 | — | — | 938 | 2500 | 143 | 32 | 380 | 85 |
| Klebsiella oxytoca | | 256 | — | — | — | — | — | — | — |
| Klebsiella oxytoca | ISI 15 | — | — | 615 | 625 | 93 | 21 | 95 | 21 |
| Listeria monocytogenes 1/2c | ISI 26 | 39 | 39 | 117 | 117 | 18* | 4 | 18* | 4 |
| Listeria monocytogenes 4a | ISI 28 | 39 | 59 | 156 | 3750 | 24 | 5 | 570 | 128 |
| Listeria monocytogenes 4b | ISI 25 | 59 | 78 | 156 | 156 | 24* | 5 | 24* | 5 |
| Listeria monocytogenes 4b | ISI 27 | 39 | 39 | 235 | 5000 | 36 | 8 | 760 | 170 |
| Lactobacillus curvatus subsp. | ISI 370 | — | — | 1250 | 10000 | 190 | 43 | 1520 | 340 |
| curvatus | | | | | | | | | |
| Lactobacillus sakei | ISI 16 | 156 | 156 | 1250 | 5000 | 190 | 43 | 760 | 170 |
| Leuconostoc mesenteroides | ISI 47 | 156 | 313 | — | — | — | — | — | — |
| Leuconostoc mesenteroides | ISI 366 | — | — | 1250 | 1250 | 190 | 43 | 190 | 43 |
| Penicillium palitans | ISI 178 | — | — | 2500 | — | 380 | 85 | — | — |
| Pichia membranifaciens | ISI 417 | — | — | 78 | 78 | 12 | 3 | 12 | 3 |
| Pseudomonas aeruginosa | ISI 30 | >5000 | >5000 | 2500 | 3750 | 380* | 85 | 570* | 128 |
| Pseudomonas fluorescens | ISI 29 | 1250 | 1250 | 78 | 156 | 12* | 3 | 24* | 5 |
| Rhodotorula mucilaginosa | ISI 33 | 78 | 156 | — | — | — | — | — | — |
| Rhodotorula mucilaginosa | ISI 496 | — | — | 313 | 625 | 48 | 11 | 95 | 21 |
| Saccharomyces cerevisiae | ISI 109 | 625 | 625 | — | — | — | — | — | — |
| Saccharomyces cerevisiae | ISI 352 | — | — | 313 | 615 | 48 | 11 | 93 | 21 |
| Saccharomyces cerevisiae | ISI 107 | — | — | 625 | 938 | 95 | 21 | 143* | 32 |
| Salmonella enteritidis PT14b | ISI 169 | 625 | 1250 | 625 | 938 | 95* | 21 | 143* | 32 |
| Salmonella enteritidis PT30 | ISI 203 | 625 | 938 | 625 | 938 | 95* | 21 | 143* | 32 |
| Salmonella enteritidis PT8 | ISI 168 | 313 | 938 | 625 | 938 | 95* | 21 | 143* | 32 |
| Salmonella Infantis FT8 | ISI 170 | 469 | 625 | 625 | 625 | 95* | 21 | 95* | 21 |
| Salmonella Senftenberg | ISI 172 | 313 | 1875 | 615 | 1250 | 93* | 21 | 190* | 43 |
| Salmonella typhimurium DT12 | ISI 166 | 313 | 625 | 625 | 625 | 95* | 21 | 95* | 21 |
| Salmonella typhimurium DT120 | ISI 167 | 313 | 1250 | 625 | 1562 | 95* | 21 | 237* | 53 |
| Serratia proteamaculans | ISI 907 | — | — | 625 | 625 | 95 | 21 | 95 | 21 |
| Shigella sonnei | ISI 35 | 625 | 625 | 1250 | 1875 | 190 | 43 | 285* | 64 |
| Sphingomonas paucimobilis | ISI 262 | — | — | 625 | 313 | 95 | 21 | 48 | 11 |
| Staphylococcus aureus | ISI 36 | 1250 | 1250 | 625 | 2500 | 95 | 21 | 380* | 85 |
| Zygosaccharomyces bailii | ISI 110 | — | — | 313 | 625 | 48 | 11 | 95 | 21 |
| Zygosaccharomyces rouxii | ISI 38 | 39 | 39 | 78 | 78 | 12* | 3 | 12* | 3 |

“—”: not determined;
Asterisks (*) indicate samples where at least a 2-fold reduction in the MIC or MBC of the organic citrus extract component was observed, as compared to the use of the organic citrus extract alone.

### Example 5

### Preparation of Concentrated Antimicrobial Compositions of Organic Citrus Extract and Lauric Arginate

Based on compatibility testing results (including those reported in Example 4) and further stability testing, antimicrobial compositions were prepared as concentrates containing organic citrus extract and lauric arginate.

### 5.1 Preparation of Antimicrobial Compositions

A) Citrus-Based Antimicrobial Compositions with a Taste-Improving Additive

All equipment was cleaned and sanitized before usage.
1. Mixture 1: In a stainless steel container, about 25% of final amount of demineralized cold water was mixed with lauric arginate powder (90-95% purity; LAEPro™). The lauric arginate was slowly added into the water, and the mixture was gently agitated with a paddle to avoid foaming until dissolution.
2. Mixture 2: In another stainless steel container, about 75% of the final amount of demineralized water was heated to approximately 70° C. The taste-improving additive (e.g., fructooligosaccharides or maltodextrin) was added and slowly mixed until dissolution, keeping the mixture at a minimum of about 60° C.
3. Mixture 1 was added to Mixture 2, and then mixed slowly.
4. Following dissolution, heating was stopped and the liquid organic citrus extract of Example 1 was slowly added, followed by further gentle mixing to avoid foaming. The mixture was then allowed to cool before packaging.
   B) Citrus-Based Antimicrobial Compositions without a Taste-Improving Additive

All equipment was cleaned and sanitized before usage. In a stainless steel container,
1. Mixture 1: In a stainless steel container, about 25% of final amount of demineralized cold water was mixed with lauric arginate powder (90-95% purity; LAEPro™). The lauric arginate was slowly added into the water, and the mixture was gently agitated with a paddle to avoid foaming until dissolution.
2. Step 2: In another stainless steel container, about 75% of the final amount of demineralized water was heated to approximately 70° C.
3. Mixture 1 was then added to Step 2, and then mixed slowly.
4. Following dissolution, heating was stopped and the liquid organic citrus extract of Example 1 was slowly added, followed by further gentle mixing to avoid foaming. The mixture was then allowed to cool before packaging.

The following concentrated antimicrobial compositions containing a fixed ratio of organic citrus extract to lauric arginate were prepared as described above and their ingredients are shown in Table 5.1. All compositions were prepared as concentrates to be diluted and used for example at the indicated starting usage concentration varying from 0.2% to 0.05% by mass, depending on the strength of the composition. Compositions A and B were prepared for usage for example in food products, and contain a taste-improving agent (e.g., fructooligosaccharides or maltodextrin). Compositions C, D, and E were prepared without a taste-improving agent for usage for example in personal care products (e.g., cosmetics), oral care products (e.g., dentifrices, dental rinses), or in surface/topical antimicrobials (e.g., disinfectants).

TABLE 5.1
Antimicrobial compositions containing fixed ratio of
organic citrus extract to lauric arginate (about 4.5:1)

| | Example of | | |
|---|---|---|---|
| | starting usage | | Quantity |
| | concentration | Ingredient | (% by mass) |
| Composition A | 0.2% by mass | Demineralized water | 59.6% |
| | (2000 ppm) | Organic citrus extract (BIOSECUR ® F440D-K) | 15.2% |
| | | Lauric arginate (LAEPro ™ powder, 90-95% purity) | 3.4% |
| | | Fructooligosaccharides (FOS) | 21.8% |
| Composition B | 0.2% by mass | Demineralized water | 59.6% |
| | (2000 ppm) | Organic citrus extract (BIOSECUR ® F440D-K) | 15.2% |
| | | Lauric arginate (LAEPro ™ powder, 90-95% purity) | 3.4% |
| | | Maltodextrin | 21.8% |
| Composition C | 0.2% by mass | Demineralized water | 81.4% |
| | (2000 ppm) | Organic citrus extract (BIOSECUR ® F440D-K) | 15.2% |
| | | Lauric arginate (LAEPro ™ powder, 90-95% purity) | 3.4% |
| Composition D | 0.1% by mass | Demineralized water | 62.8% |
| | (1000 ppm) | Organic citrus extract (BIOSECUR ® F440D-K) | 30.4% |
| | | Lauric arginate (LAEPro ™ powder, 90-95% purity) | 6.8% |
| Composition E | 0.05% by mass | Demineralized water | 25.6% |
| | (500 ppm) | Organic citrus extract (BIOSECUR ® F440D-K) | 60.8% |
| | | Lauric arginate (LAEPro ™ powder, 90-95% purity) | 13.6% |

When Compositions A-E are diluted and used at the above indicated starting usage concentrations, the final concentration (e.g., in or on a food product, cosmetic, or product/surface to be treated) of the organic citrus extract is about 304 ppm, and the concentration of lauric arginate is about 68 ppm.

### 5.2 Thermal Stability Testing of Antimicrobial Compositions

Thermal stability testing revealed that the organic citrus extract of Example 1 is stable (i.e., retained its antimicrobial activity) at 121° C. (250 F) for 15 minutes, and at 100° C. (212 F) for 30 minutes. Lauric arginate has been reported to be resistant to all types of thermal processing including boiling.

It was noted that the use of excessive heat (higher than about 70° C.) during the manufacture process for the preparation of compositions A and B described in Example 5.1, resulted in precipitations and reduced antimicrobial efficacy of compositions A and B (data not shown). However, when prepared in the absence of excessive heat (e.g., as described in Example 5.1), compositions A and B showed thermal stability and no loss of antimicrobial activity at 121° C. (250 F) for 20 minutes.

### Example 6

### MIC Testing of Composition a and Comparison with Sodium Benzoate

The minimum inhibitory concentration (MIC) of Composition A of Example 5 was determined and compared to that of sodium benzoate (a synthetic preservative commonly used in the food and beverage industry).

### 6.1 Preparation of Pathogen Cultures

Stock cultures of E. coli ATCC 25922, Salmonella typhimurium, Listeria monocytogenes, Staphylococcus aureus ATCC 25923, and Bacillus cereus were stored at −80° C. in Tryptic Soy Broth (TSB) medium (Alpha Biosciences Inc., Baltimore, Md., USA) containing glycerol (10% v/v). Stock cultures of Aspergillus niger, Xeromyces bisporus ATCC MY-36964, and Zygosaccharomyces rouxii ATCC (R) 95-12 13356 were stored at −80° C. in Potato Dextrose Broth (PDB) medium (Alpha Biosciences Inc.). Prior to each experiment, stock cultures were grown through two consecutive 24-48 h growth cycles in TSB at 37° C. or in PDB at 28° C. Working cultures were diluted in peptone water in order to obtain the bacterial concentration of each culture adjusted to 10⁶ CFU/mL (resp. 10⁶ conidia/mL) for MIC determination or 10³-10⁴ CFU/mL (resp. 10³-10⁴ conidia/mL) for in situ tests.

### 6.2 Measurement of the MIC by Broth Dilution Method in 96-Well Microplates

MIC determination was carried out according to a modified procedure from Turgis et al. (2012). One 96-well microplate (Sarstedt, Montreal, QC, Canada) was used to evaluate the effect of one antimicrobial on one microbial culture. All media and samples were prepared under sterile conditions. Briefly, serial binary dilutions of the antimicrobial solution to be tested (Composition A or sodium benzoate) were prepared in columns 1 to 11 of a microplate, in Mueller Hinton Broth (MHB). For composition A, serial concentrations from 880 to 1 ppm were obtained. For sodium benzoate, serial concentrations from 41 480 to 40 ppm were obtained. Each well was then inoculated with 15 μL of a pathogenic strain at a concentration of 10⁶ CFU/mL (resp. 10⁶ conidia/mL) in rows A-F. Column 12 was used for the measurement of a positive control (growth of the pathogen in MHB without antimicrobial solution). Wells in rows G-H were used for the measurement of the blank, which was an equal volume of MHB with the antimicrobial but without the pathogen.

Microplates were incubated aerobically for 24 h at 37° C. (resp. 28° C.), under stirring at 800 rpm by using an MS1 S7 microtiter plate shaker (Fisher Scientific, Ottawa, ON, Canada). Then, the absorbance was measured at 595 nm in a BioTek™ ELx800 absorbance microplate reader (BioTek Instruments Inc., Winooski, Vt., USA). The MIC is defined as the lowest concentration of antimicrobial indicating a total growth inhibition of tested strains (related to sample absorbance equal to blank absorbance). All measurements were performed in triplicate (n=3).

### 6.3 MIC of Composition A Vs Sodium Benzoate

The MIC values of Composition A and sodium benzoate against selected bacteria, yeasts, and molds are presented in Table 6.1.

TABLE 6.1
MIC of Composition A and sodium benzoate for
different classes or microorganisms

| | | | MIC in ppm | |
|---|---|---|---|---|
| | Microorganism | Strain | Composition A | Sodium benzoate |
| Gram(−) | Escherichia coli | EDL 933 | 220 | 10 730 |
| bacteria | Salmonella typhimurium | SL1344 | 440 | 5 185 |
| Gram(+) | Listeria monocytogenes | HPB 2812 | 220 | 5 185 |
| bacteria | Staphylococcus aureus | ATCC 25923 | 4 | 5 185 |
| | Bacillus cereus | L8PQ | 220 | 5 185 |
| Mold | Aspergillus niger | ATCC 1015 | 7 | 648 |
| | Xeromyces bisporus | ATCC MY-36964 | 4 | 81 |
| Yeast | Zygosaccharomyces rouxii | ATCC R 995 | 4 | 162 |

The results in Table 6.1 show that the MICs of Composition A for each of the microorganisms tested are lower (i.e., more potent) than the MIC for sodium benzoate. Furthermore, the ability to inhibit growth of different classes of microorganisms suggests that Composition A may possess a broad spectrum antimicrobial capacity.

### 6.4 MIC of Composition A Vs Organic Citrus Extract

To facilitate comparisons between the antimicrobial activity of Composition A with that of the organic citrus extract alone, the MICs of the organic citrus extract (OCE) and lauric arginate (LAE) components of Composition A (from Table 6.1) were compared side-by-side with the MICs of organic citrus extract alone (from Table 2.1) in Table 6.2 below. For ease of reference, values appearing in bold highlight the concentrations (in ppm) of the organic citrus extract component. The right-most column indicates the fold-reduction in the concentration of the organic citrus extract component in the MIC of Composition A, as compared to the organic citrus extract alone.

TABLE 6.2
Comparison of Composition A and organic citrus extract (OCE) alone

| | | MIC in ppm | | | | |
|---|---|---|---|---|---|---|
| | | OCE | Composition A | | | Fold reduction |
| | | extract | MIC of | | | in OCE |
| | | alone | Composition | OCE | LAE | required for |
| | | (from | A from | component | component | inhibition in |
| Microorganism | Strain | Table 2.1) | Table 7.1 | (15.2%) | (3.4%) | Composition A |
| Aspergillus niger | ATCC | — | 7 | 1.1 | 0.24 | — |
| | 1015 | | | | | |
| Bacillus cereus | L8PQ | 750 | 220 | 33 | 7.5 | 22.7 |
| Escherichia coli | EDL 933 | 240 | 220 | 33 | 7.5 | 7.3 |
| Listeria monocytogenes | HPB 2812 | 20 | 220 | 33 | 7.5 | 0 |
| Salmonella typhimurium | SL1344 | —* | 440 | 67 | 7.5 | — |
| Staphylococcus aureus | ATCC | 20 | 4 | 0.61 | 0.14 | 32.8 |
| | 25923 | | | | | |
| Xeromyces bisporus | ATCC | — | 4 | 0.61 | 0.14 | — |
| | MY-36964 | | | | | |
| Zygosaccharomyces | ATCC R | 78 | 4 | 0.61 | 0.14 | 127.9 |
| rouxii | 995 | | | | | |

“—”: not determined;
*Although the MIC of S. typhimurium strain SL1344 was not reported in Table 2.1, results obtained with other strains of S. typhimurium (ISI 166 and ISI 167) showed a MIC of 313 ppm for the organic citrus extract alone.

### Example 7

### Antimicrobial Efficacy Testing of Composition A In Vitro

### 7.1 USP <51> Antimicrobial Effectiveness Testing

The antimicrobial efficacy of Composition A diluted to 0.2% (the “product”) was evaluated according to USP <51> version 35. The tests were performed in triplicate using three different lots of Composition A, and each separate test gave consistent results. The results of one of the tests are shown in Table 7.1.

TABLE 7.1
Results from USP <51>Antimicrobial
Effectiveness Test of Composition A at 0.2%

| | | | | |
|---|---|---|---|---|
| | Count in 1.0 g | Count in 1.0 g | | Increase of |
| | of product | of product | Log | calculated |
| Microorganism | (time zero) | after X days | reduction | count? |

X = After 7 days

| | | | | |
|---|---|---|---|---|
| Staphylococcus aureus ATCC 6538 | 500 000 | <10 | >4.70 | No |
| Pseudomonas aeruginosa ATCC 9027 | 165 000 | <10 | >4.59 | No |
| Escherichia coli ATCC 8739 | 424 000 | <10 | >4.75 | No |
| Candida albicans ATCC 10231 | 333 334 | <10 | >4.54 | No |
| Aspergillus brasiliensis ATCC 16404 | 21 334 | 10 | 3.56 | No |

X = After 14 days

| | | | | |
|---|---|---|---|---|
| Staphylococcus aureus ATCC 6538 | 500 000 | <10 | >4.70 | No |
| Pseudomonas aeruginosa ATCC 9027 | 165 000 | <10 | >4.59 | No |
| Escherichia coli ATCC 8739 | 424 000 | <10 | >4.75 | No |
| Candida albicans ATCC 10231 | 333 334 | <10 | >4.54 | No |
| Aspergillus brasiliensis ATCC 16404 | 21 334 | 10 | 3.56 | No |

X = After 28 days

| | | | | |
|---|---|---|---|---|
| Staphylococcus aureus ATCC 6538 | 500 000 | <10 | >4.70 | No |
| Pseudomonas aeruginosa ATCC 9027 | 165 000 | <10 | >4.59 | No |
| Escherichia coli ATCC 8739 | 424 000 | <10 | >4.75 | No |
| Candida albicans ATCC 10231 | 333 334 | <10 | >4.54 | No |
| Aspergillus brasiliensis ATCC 16404 | 21 334 | <10 | >3.32 | No |

The above results show that Composition A diluted to 0.2% by mass was in compliance with the criteria of USP <51> for each microorganism tested.

7.2 Antimicrobial Effectiveness Testing Against E. coli, S. enterica, and L. monocytogenes

Composition A was diluted to 0.2% by mass in sterile water and contacted with different microorganisms for 30 seconds, after which the total microbial count was determined using standard methods. The tests were performed in duplicate using two different lots of Composition A, and each test gave consistent results. The results of one of the tests are shown in Table 7.2.

TABLE 7.2
Results from antimicrobial effectiveness testing
of Composition A at 0.2% by mass

| | Total microbial count; | | | |
|---|---|---|---|---|
| | Contact length: 30 seconds | | | |
| | | Control | Composition A at | Log |
| Microorganism | ATCC | (untreated) | 0.2% by mass | reduction |
| Escherichia coli | 8739 | 86 000 | <1 | >4.93 |
| Salmonella enterica | 14028 | 57 000 | <1 | >4.76 |
| Listeria | 19115 | 62 000 | <1 | >4.79 |
| monocytogenes | | | | |

### Example 8

### Efficacy Testing of Composition A in Food Products

The antimicrobial efficacy of Composition A as described in Example 5 was examined in various food products.

### 8.1 Antimicrobial Capacity in Strawberry Fillings and Strawberry Flavor Puddings

The antimicrobial activity of Composition A (at 0.2% by mass) incorporated in strawberry fillings (SF) and in strawberry flavor puddings (SFP), as compared to sodium benzoate (0.1% by mass), was evaluated in situ against 8 pathogens: E coli, S. aureus, B. cereus, L. monocytogenes, S. typhimurium, X. bisporus, and Z. rouxii. Microorganism cultures were prepared as described in Example 6.1, unless otherwise indicated.

SF and SFP samples (25 g) were inoculated with each microbial culture (inoculum concentration of 10⁴CFU/g or 10⁴ conidia/g) and then stored for 28 days at 4° C. Microbiological analyses were performed at days 1, 3, 7, 14, 21 and 28. Samples were homogenized for 2 min at 260 rpm in 50 mL of sterile peptone water (0.1% w/v) with a Lab-Blender™ 400 stomacher (Laboratory Equipment). From each homogenate, serial dilutions were prepared, surface-plated onto tryptic soy agar (TSA; Difco, BD) for bacteria or potato dextrose agar (PDA; Difco) for yeasts/molds, and incubated for 24-48 h at 37° C. (resp. 28° C.) before bacteria (resp. conidia) enumeration (minimum level of detection: 10 CFU/g (resp. 10 conidia/g).

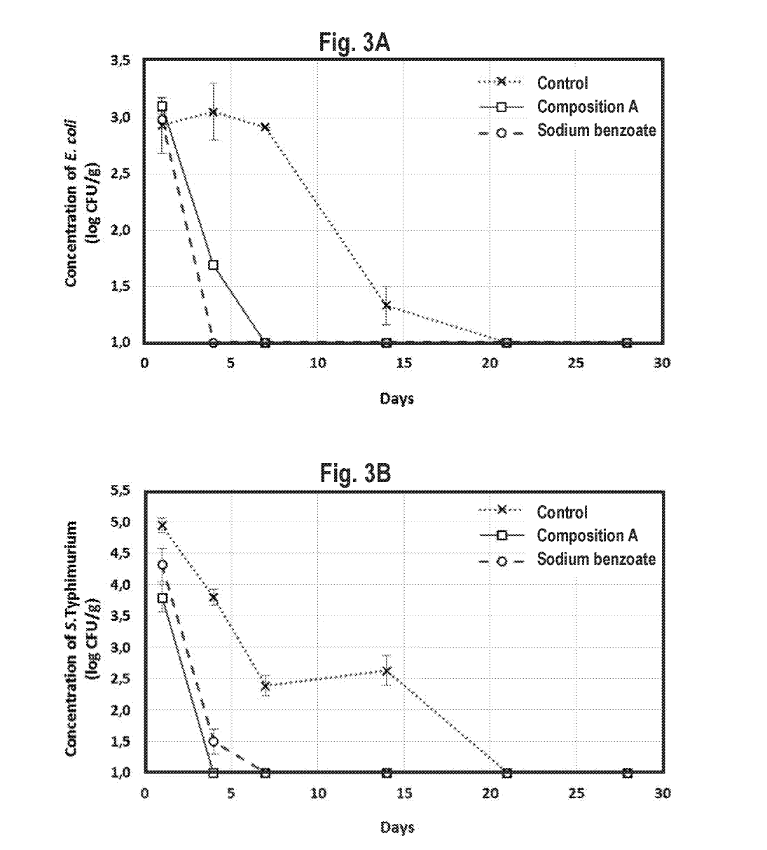

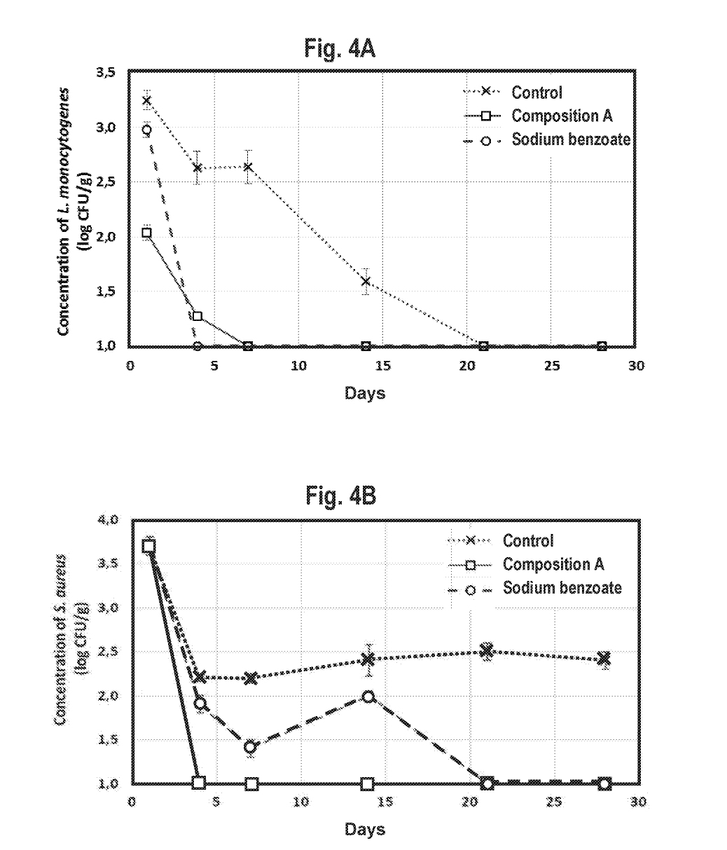

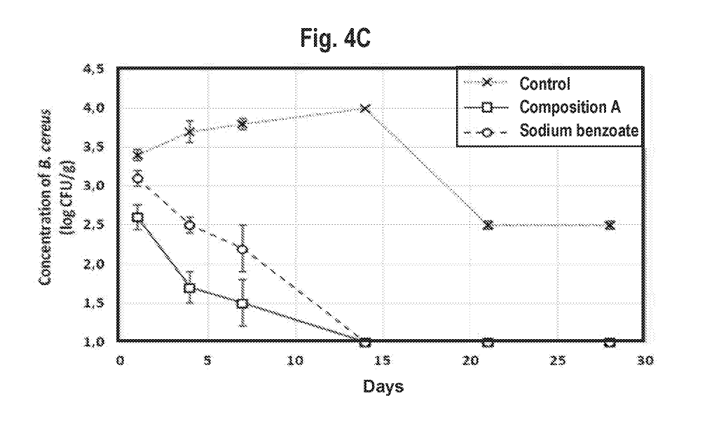

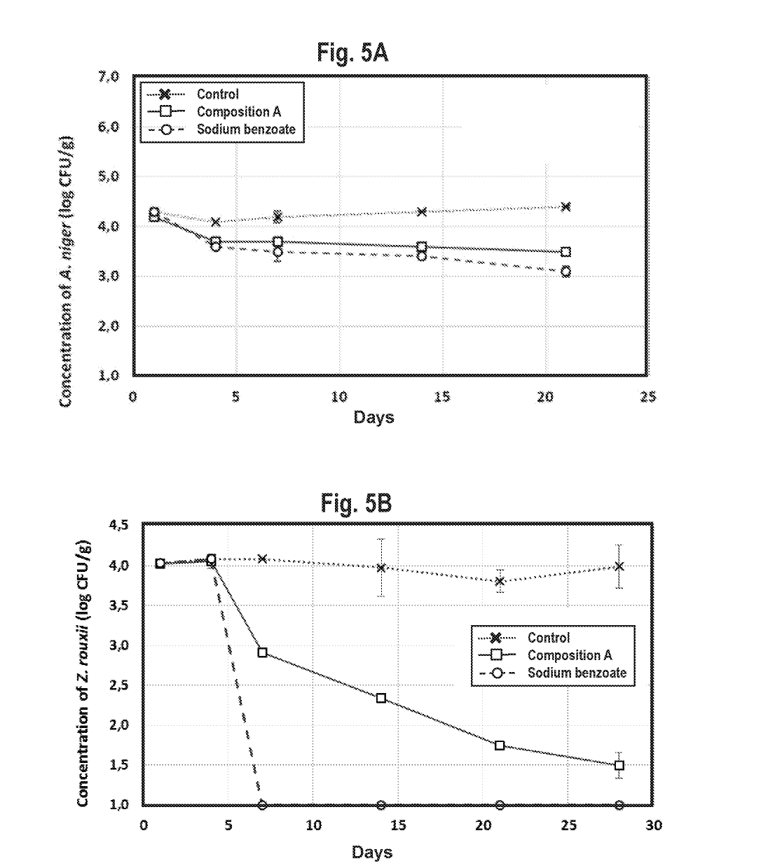

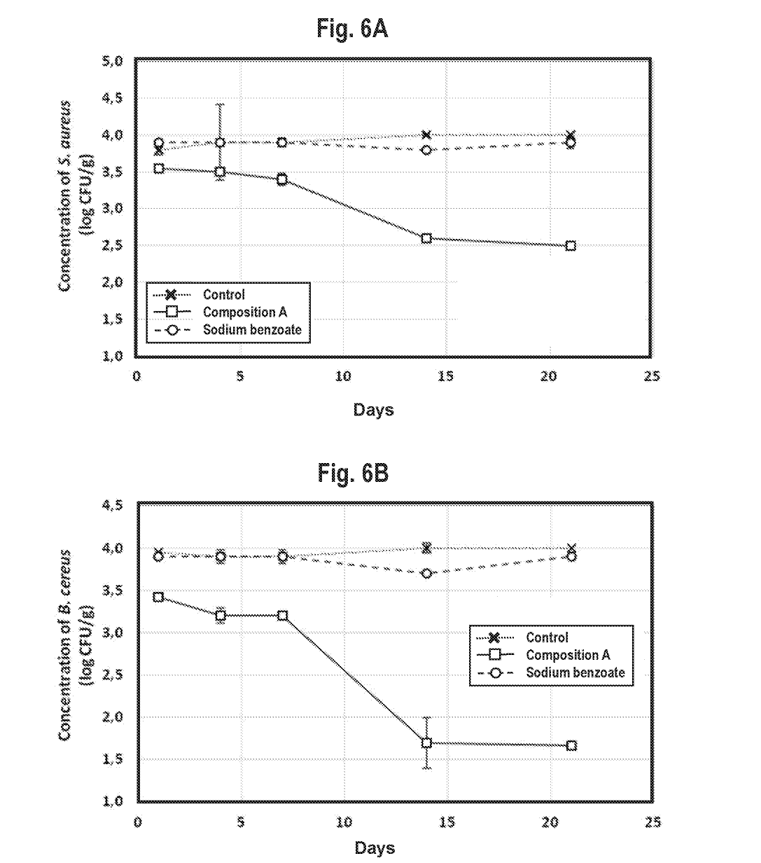

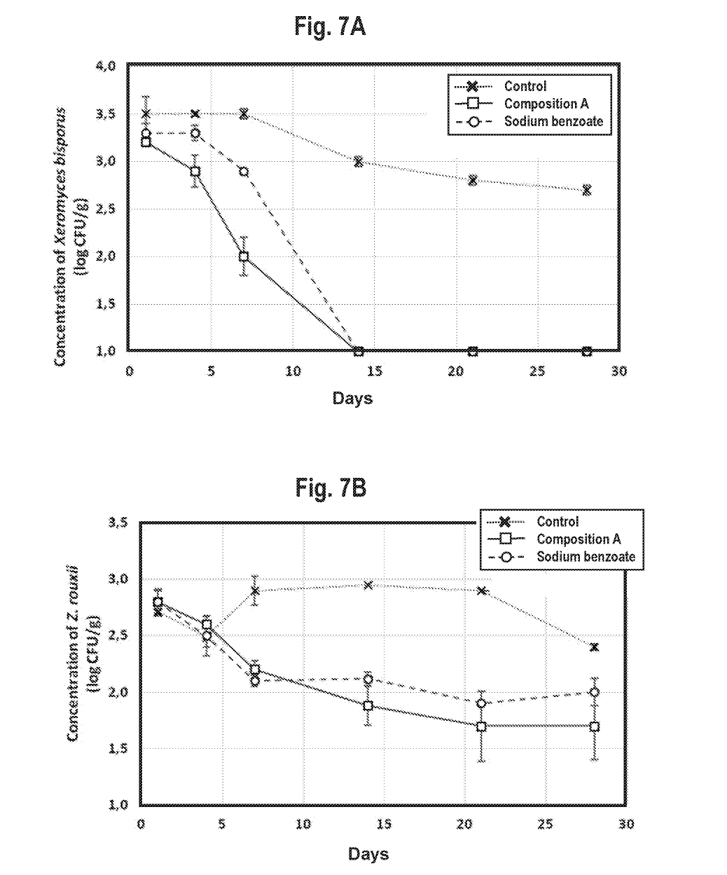

Results in strawberry fillings are shown in FIGS. 3-5, while the results in strawberry flavor puddings are shown in FIGS. 6-7.

### 8.2 Shelf-Life of Strawberry Fillings and Strawberry Flavor Puddings

The shelf-life of the strawberry fillings and strawberry flavor puddings, containing 0.2% by mass Composition A or 0.1% by mass sodium benzoate, was investigated by an AOAC accelerated method at 35° C., from a procedure by Kilcast and Persis (2000) by determining the concentration of total aerobic microflora (TAM) and yeast/molds (YM). Samples (25 g) were stored at 28° C. under 70% relative humidity (RH) in a Shellab humidity chamber (model 9010L; Sheldon Manufacturing Inc., Cornelius, Oreg., USA), in order to simulate an accelerated maturity of the products. A storage time of 2 weeks in these conditions corresponds to 6 months in normal conditions (20° C., 45% RH). Microbiological analyses were performed at Days 0, 3, 7, 14, 21 and 28. Samples were homogenized for 2 min at 260 rpm in 50 mL of sterile peptone water (0.1% w/v) with a Lab-Blender™ 400 stomacher (Laboratory Equipment, London, UK). From each homogenate, serial dilutions were prepared, plated onto surface of Plate Count Agar (PCA) (Difco, BD) for TAM enumeration or PDA for YM enumeration and incubated for 24-48 h at 37° C. (resp. 28° C.) before counting.

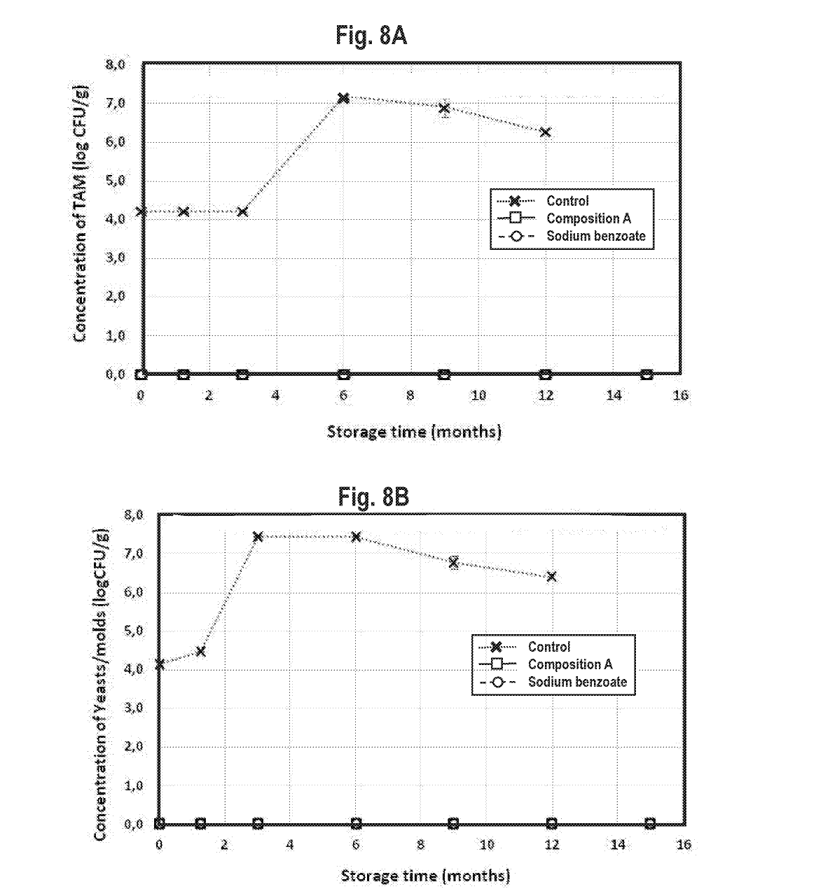

The shelf-life of strawberry fillings containing 0.2% by mass Composition A or 0.1% by mass sodium benzoate according to the above described accelerated procedures is represented in FIG. 8 for 35 days of storage at 28° C. and 70% RH, which represents a storage of about 15 months at 4° C. (refrigerated conditions). The results show that strawberry fillings with Composition A or sodium benzoate exhibited and maintained a total inhibition of TAM concentration (FIG. 8A) and Yeast/Mold (Y/M) concentration (FIG. 8B) of from Month 1 to Month 15, as compared to strawberry fillings with no preservative (“control”).

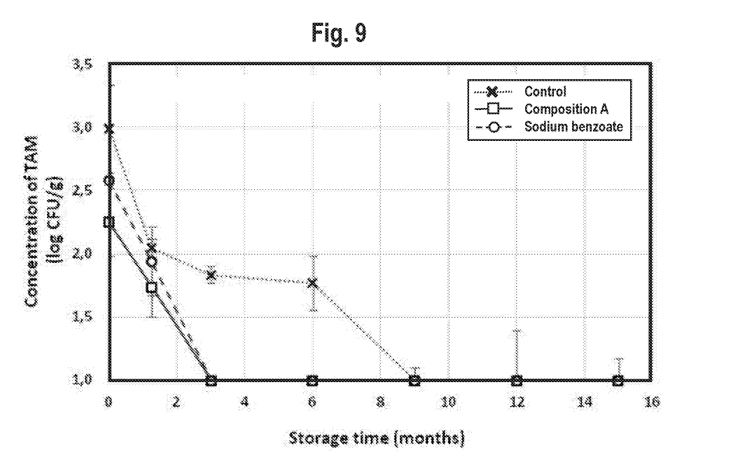

The shelf-life of strawberry flavor puddings containing 0.2% by mass Composition A or 0.1% by mass sodium benzoate according to the above described accelerated procedures is represented in FIG. 9 for 35 days of storage at 28° C. and 70% RH, which represents a storage of about 15 months at 4° C. (refrigerated conditions). The results in FIG. 9 show that strawberry flavor puddings with Composition A exhibited similar TAM concentrations levels as compared to sodium benzoate. Furthermore, Yeast/Mold (Y/M) concentration measurements revealed that no growth of Y/M was observed for all strawberry flavor pudding groups (control, 0.2% Composition A, and 0.1% sodium benzoate) after 35 days of storage in accelerated conditions (i.e., 15 months) (data not shown).

### 8.3 Sensory Analysis of the Strawberry Fillings

The appearance (color, texture, odor, flavor and global appreciation of the strawberry fillings were evaluated by a panel comprising 30 persons, according to a 9-points hedonic scale test. This method was used in order to measure the degree of acceptance or rejection of samples, and eventually to verify if the addition of natural antimicrobial has no significant negative effect (p>0.05) on the organoleptic properties of the strawberry filling samples. Analysis of variance (ANOVA), Duncan's multiple range test (for equal variances) and Tamhane's post-hoc test (for unequal variances) were performed for statistical analysis (PASW Statistics 18; IBM Corporation, Somers, N.Y., USA). Differences between means were considered significant when the confidence interval was lower than 5% (p 0.05).

The sensory evaluation of strawberry fillings samples containing no preservative (control), 0.2% Composition A, or 0.1% sodium benzoate is presented in Table 8.1. The color, texture, odor, flavor and global appreciation of the strawberry fillings were determined according to 9-points scale hedonic test, resulting in degrees of appreciation, from 1 (Dislike very much) to 9 (Like very much).

TABLE 8.1
Effect of 0.2% Composition A or 0.1% sodium benzoate
on sensory properties of strawberry fillings

| | Sensory properties¹⁻³ | | | | |
|---|---|---|---|---|---|
| Strawberry | | | | | Global |
| fillings samples | Color | Texture | Odor | Flavor | appreciation |
| Control | 6.83 ± 1.20^{a} | 6.36 ± 1.79^{a} | 7.64 ± 0.76^{b} | 7.32 ± 1.11^{b} | 7.28 ± 1.21^{a} |
| 0.2% Composition A | 6.70 ± 1.18^{a} | 5.69 ± 2.02^{a} | 7.60 ± 0.91^{ab} | 5.14 ± 2.46^{a} | 7.25 ± 1.29^{a} |
| 0.1% sodium benzoate | 6.81 ± 1.27^{a} | 6.68 ± 1.41^{a} | 6.69 ± 1.71^{a} | 6.69 ± 1.71^{b} | 6.72 ± 1.06^{a} |

¹The hedonic evaluation was scaled as follow: 9 = Like very much; 8 = Like a lot; 7 = Like moderately; 6 = Like a little; 5 = Indifferent; 4 = Dislike a little; 3 = Dislike moderately; 2 = Dislike a lot; 1 = Dislike very much.
²Data were compared according to Duncan's test for assumed equal variances or according to Tamhane's test for assumed unequal variances. The equality of variances was determined by Levene's test and Weich and Brown-Forsythe's robust tests were applied to assume the equality of means.
³Means with different letters within the same column are significantly different (p ≦ 0.05).

Results show that the incorporation of 0.2% by mass of Composition A did not significantly affect (p>0.05) the color, texture, odor and global appreciation of the strawberry fillings. These results mean that these 4 criteria were similar for all strawberry fillings groups and the degree of appreciation was:
“Like moderately” for color;
“Like a little-Like moderately” for texture;
“Like moderately-Like a lot” for odor;
“Like moderately-Like a lot” for global appreciation.

For odor analysis, results indicate more accurately that no significant difference (p>0.05) was observed between control (no preservative) and 0.2% by mass of Composition A, with hedonic values of 7.6 oriented to “Like a lot”. However, a significant difference (p≦0.05) was observed between control and sodium benzoate, with a value of 6.7 for benzoate tending to “Like moderately”. Therefore, the analysis of odor revealed a good appreciation “Like a lot” of odor for control and 0.2% Composition A, whereas 0.1% sodium benzoate was less appreciated with a “Like moderately” level. As a result, the incorporation of 0.2% Composition A did not affect the odor of strawberry fillings with similar values to control as compared to a lower appreciation obtained with the addition of sodium benzoate.

For flavor analysis, results show that no significant difference was observed between control and sodium benzoate, with hedonic values of 7.3 for control and 6.7 for sodium benzoate, both oriented to “Like moderately”. However, strawberry fillings containing 0.2% Composition A led to a slightly lower value of 5.1, indicating an “Indifferent” level. Thus, the incorporation of 0.2% Composition A did not affect negatively the flavor of the strawberry filling, with a neutral hedonic value (5.1). Finally, no negative effect (“Dislike a little” or lower appreciation) was reported on the organoleptic properties of all strawberry filling samples.

### Example 9

### Comparison of Compositions A and B

The antimicrobial activity of Composition B prepared as described in Example 5 was compared to that of Composition A in the tests described in Examples 6 and 8. Results showed that Composition B behaved comparably to Composition A in terms of antimicrobial efficacy, sensory properties, and shelf-life.

### REFERENCES

Andrews, J. M., “Determination of minimum inhibitory concentrations”. J Antimicrob Chemother 2002 June; 49(6):1049.
Battey et al., Appl Environ Microbiol. 2002. 68(4):1901-6.
Kilcast D., Persis S. (eds). (2000). “The stability and shelf life of food”. CRC Press.
Turgis et al., (2012). “Combined antimicrobial effect of essential oils and bacteriocins against foodborne pathogens and food spoilage bacteria”. Food Res. Int. 48, 696-702.

1. A citrus-based antimicrobial composition comprising citrus extract and lauric arginate.

2. The citrus-based antimicrobial composition of claim 1 consisting essentially of citrus extract and lauric arginate as a processing aid and/or stabilizer.

3. The composition of claim 1, wherein said citrus extract is, or is from, an aqueous citrus extract comprising a total bioflavonoid concentration of at least 0.3%, 0.35%, 0.4%, 0.45%, or 0.5% by mass, and a total polyphenol concentration of at least 2%, 2.1%, 2.2%, 2.3%, 2.4%, 2.5%, 2.6%, or 2.7% by mass, based on the total mass of the aqueous citrus extract.

4. The composition of claim 1, wherein said citrus extract is, or is from, an aqueous citrus extract comprising a total bioflavonoid concentration of 0.2% to 1.5% by mass, and a total polyphenol concentration of 1.5% to 6% by mass, based on the total mass of the aqueous citrus extract.

5. The composition of claim 1, wherein:
(i) the ratio of citrus extract to lauric arginate by mass in said composition is between 1.5:1 and 6:1, between 2:1 and 6:1, between 2.5:1 and 6:1, between 3:1 and 6:1, between 4:1 and 5.5:1, between 4:1 and 5:1, or about 4.5:1;
(ii) the ratio of total bioflavonoids to lauric arginate by mass in said composition is equivalent to that defined in (i), based on the aqueous citrus extract as defined in claim 3;
(iii) the ratio of total polyphenols to lauric arginate by mass in said composition is equivalent to that defined in (i), based on the aqueous citrus extract as defined in claim 3; or
(iv) any combination of (i) to (iii).

6. The composition of claim 1, wherein said citrus extract:
(a) comprises an extract from Citrus aurantium amara;
(b) comprises an extract from Citrus reticulate;
(c) comprises an extract from Citrus sinensis;
(d) does not comprise an extract from Citrus paradise; or
(e) any combination of (a) to (d).

7. The composition of claim 1, wherein said composition further comprises an additive, a suitable carrier, stabilizer, taste-improving agent, or any combination thereof.

8. The composition of claim 7, wherein:
(i) said additive comprises citrus bioflavonoids and/or citrus polyphenols;
(ii) said suitable carrier comprises glycerin and/or silicon dioxide;
(iii) said stabilizer comprises ascorbic acid, citric acid, lactic acid, or any combination thereof;
(iv) said taste-improving agent is a sweetener, a natural sweetener, a polysaccharide, an oligosaccharide, a fructooligosaccharide, a maltodextrin, sucrose, sucralose, isomerized sugar, glucose, fructose, lactose, maltose, xylose, isomerized lactose, maltooligosaccharide, isomaltooligosaccharide, galactooligosaccharide, coupling sugar, paratinose, maltitol, sorbitol, erythritol, xylitol, lactitol, paratinit, saccharification product of reduced starch, stevia, glycyrrhizin, thaumatin, monelin, aspartame, alitame, saccharin, acesulfame-K, sucralose, dulcin, neotame, agave syrup, a low glycemic index carbohydrate, or any combination thereof; or
(v) any combination of (i) to (iv).

9. The composition of claim 1, wherein said composition does not comprise a further antimicrobial agent.

10. The composition of claim 1, wherein said composition does not comprise a further antimicrobial agent which is a benzoate, a benzoate salt, benzyl alcohol, or any combination thereof.

11. The composition of claim 1, wherein said composition does not comprise a further antimicrobial agent which is thymol.

12. The composition of claim 1, wherein said composition does not comprise a further antimicrobial agent which is an essential oil and/or phenylethanol.

13. The composition of claim 1, wherein said composition does not comprise a further antimicrobial agent which is a quaternary compound and/or a quaternary ammonium compound.

14. The composition of claim 3, wherein said composition comprises between 30, 40, 50, 60, 70, 10, 90, or 100 ppm and 200, 250, 300, 350, 400, 450, 500, 550, or 600 ppm of said citrus extract.

15. The composition of claim 3, wherein said composition comprises a concentration of lauric arginate of between 30, 35, 40, 45, or 50 ppm and 55, 60, 65, 70, 75, 80, 85, 90, 95, or 100 ppm.

16. The composition of claim 1, wherein said composition is in the form of a concentrate, a liquid, a gel, a powder, or a solid.

17. The composition of claim 1, wherein said composition is formulated as a flavoring agent, a colorant, an antioxidant, a preservative, or any combination thereof.

18. The composition of claim 1, wherein said composition is comprised in or on a food product, a cosmetic, a personal care product, an oral care product, an industrial, or a pharmaceutical, or a surface antimicrobial.

19. A method for preparing a citrus-based antimicrobial composition, said composition consisting essentially of a citrus extract, lauric arginate as a processing aid and/or stabilizer, and a taste-improving agent, said method comprising:
(a) dissolving said lauric arginate in demineralized water to form mixture I;
(b) dissolving said taste-improving agent in demineralized water heated to between 65° C. and 75° C., or to about 70° C., to form mixture II;
(c) mixing mixtures I and II to form mixture III, while maintaining a temperature at a minimum of 60° C.; and
(d) adding citrus extract to mixture III,
thereby preparing said citrus-based antimicrobial composition.

20. A citrus-based antimicrobial composition consisting of:
(a) an aqueous citrus extract, lauric arginate as a processing aid and/or stabilizer, and water; or
(b) an aqueous citrus extract, lauric arginate as a processing aid and/or stabilizer, water, and one of more of an additive, a suitable carrier, a stabilizer, and a taste-improving agent;
wherein said citrus extract, before being added to said composition, comprises a total bioflavonoid concentration of 0.2% to 1.5% by mass, and a total polyphenol concentration of 1.5% to 6% by mass, based on the total mass of the aqueous citrus extract; and
wherein the ratio of citrus extract to lauric arginate by mass in said composition is between 1.5:1 and 6:1, between 2:1 and 6:1, between 2.5:1 and 6:1, between 3:1 and 6:1, between 4:1 and 5.5:1, between 4:1 and 5:1, or about 4.5:1.
